(19) United States
(12) Patent Application Publication
(10) Pub. No.: US 2023/0080923 A1
(43) Pub. Date: Mar. 16, 2023

(54) SYSTEMS AND METHODS FOR PROVIDING REAL-TIME ASSISTANCE

(71) Applicant: Vocollect, Inc., Pittsburgh, PA (US)

(72) Inventors: Luke A. Sadecky, New Kensington, PA (US); Mark Meagher, Woodbury, NJ (US); James Wise, Matthews, NC (US)

(21) Appl. No.: 17/474,130

(22) Filed: Sep. 14, 2021

(51) Int. Cl. G09B 5/02; G08B 7/06; H04Q 9/00

(52) U.S. Cl. CPC G09B 5/02; G08B 7/06; H04Q 9/00

(57) ABSTRACT

A method for providing real-time information to a first electronic device is described here. The method includes transmitting one or more workflow tasks from a host computer to a first electronic device communicatively coupled to the host computer. Further, the method comprises receiving sensor information from a plurality of sensors. The sensor information comprises at least one of a location of the first electronic device or data related to the one or more workflow tasks being performed by a worker. The method further comprises transmitting, to the first electronic device, a real-time information to be communicated to the worker based on the sensor information received from the plurality of sensors. In some examples, the real-time information comprises instructions in form of an assistance to be provided to the worker for performing the one or more workflow tasks.

### TECHNOLOGICAL FIELD

Example embodiments described herein relate generally to systems, methods, and apparatuses for providing assistance/feedback to the workers in real-time or near real-time.

### BACKGROUND

In modern production environments and warehouses, it is increasingly desirable for human operators to use portable electronic voice-processing devices for performing workflow tasks provided with real-time instructions and feedbacks. However, assessing performance of each of the workers and ensuring safety of the workers might be a key challenge.

### SUMMARY

The following presents a simplified summary to provide a basic understanding of some aspects of embodiments described herein. This summary is not an extensive overview and is intended to neither identify key or critical elements nor delineate the scope of such elements. Its purpose is to present some concepts of the described features in a simplified form as a prelude to the more detailed description that is presented later.

A system is described in accordance with some example embodiments. The system comprises a host computer communicatively coupled to a first electronic device. The host computer includes a processor configured to perform the steps. The processor is configured to transmit one or more workflow tasks to the first electronic device. The processor then receives sensor information from a plurality of sensors. The sensor information comprises at least one of a location of the first electronic device or data related to the one or more workflow tasks being performed by a worker. Further, the processor is configured to transmit, to the first electronic device, real-time information to be communicated to the worker based on the sensor information received from the plurality of sensors. In this regard, the real-time information can include instructions in form of an assistance to be provided to the worker for performing the one or more workflow tasks.

A system is described in accordance with another example embodiments. The system includes a memory to store computer-executable instructions and a processor, that performs operations in response to executing the computer-executable instructions. The operations can include transmitting an inspection plan comprising a sequence of inspection steps to a first inspection assistance device associated with a worker. Further, the operations can include receiving sensor information from a plurality of sensors. In this regard, the sensor information comprises data related to the sequence of inspection steps to be performed using the first inspection assistance device. Further, the operations can include evaluating a performance of the worker in real-time based on comparing the received sensor information with an AI based trained model. Furthermore, the operations can include, in response to the evaluation of the performance of the worker, transmitting real-time information to the first inspection assistance device. The real-time information comprises instructions in form of assistance to be provided to the worker for performing an inspection.

According to some example embodiments, a method includes transmitting one or more workflow tasks from a host computer to a first electronic device communicatively coupled to the host computer. Further, the method includes receiving sensor information from a plurality of sensors. The sensor information comprises at least one of a location of the first electronic device or data related to the one or more workflow tasks being performed by a worker. Furthermore, the method includes transmitting, to the first electronic device, a real-time information to be communicated to the worker based on the sensor information received from the plurality of sensors. The real-time information comprises instructions in form of an assistance to be provided to the worker for performing the one or more workflow tasks.

According to some example embodiments, a method includes transmitting, by a processor, an inspection plan comprising a sequence of inspection steps to a first inspection assistance device associated with a worker. Further, the method includes receiving, by the processor, sensor information from a plurality of sensors. The sensor information comprises data related to the sequence of inspection steps to be performed using the first inspection assistance device. Furthermore, the method includes evaluating, by the processor, a performance of the worker in real-time based on comparing the received sensor information with an AI based trained model. Further, the method includes in response to the evaluation of the performance of the worker, transmitting, by the processor, real-time information to the first inspection assistance device. The real-time information comprises instructions in form of assistance to be provided to the worker for performing the given inspection.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which will be further described below.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 illustrates a schematic of a workflow performance system according to an example embodiment.

FIG. 2 illustrates an exemplary voice-controlled apparatus used for performing a workflow operation, according to an example embodiment.

FIG. 3 illustrates an exemplary user device according to an example embodiment.

FIG. 4 illustrates a schematic block diagram of a workflow performance system according to an example embodiment.

FIG. 5 illustrates a block diagram of the voice-controlled apparatus used for performing a workflow operation, in accordance with an example embodiment.

FIG. 6 illustrates an exemplary implementation of a work management system in an exemplary warehouse, in accordance with an example embodiment.

FIG. 7 shows a flowchart illustrating a method of utilizing voice-driven technology according to an example embodiment.

FIG. 8 illustrates a flow diagram representing a method for providing real-time information to a first electronic device, in accordance with another example embodiment described herein.

FIG. 9 illustrates a flow diagram representing another method for providing real-time information to a first inspection assistance device, in accordance with another example embodiment described herein.

FIG. 10 illustrates an example scenario depicting an inspection system, in accordance with an example embodiment.

FIG. 11 illustrates an exemplary table depicting a performance metric of workers, in accordance with an example embodiment.

FIG. 12 illustrates a schematic view of an example electronic device used for performing a workflow operation, in accordance with an example embodiment.

FIG. 13 illustrates a schematic view of another example electronic device used for performing a workflow operation, in accordance with another example embodiment.

### DETAILED DESCRIPTION

Some embodiments of the present disclosure will now be described more fully hereinafter with reference to the accompanying drawings, in which some, but not all embodiments of the disclosure are shown. Indeed, the disclosure may be embodied in many different forms and should not be construed as limited to the embodiments set forth herein; rather, these embodiments are provided so that this disclosure will satisfy applicable legal requirements. The terms “or” and “optionally” are used herein in both the alternative and conjunctive sense, unless otherwise indicated. The terms “illustrative” and “exemplary” are used to be examples with no indication of quality level. Like numbers refer to like elements throughout.

The components illustrated in the figures represent components that may or may not be present in various embodiments of the disclosure described herein such that embodiments may comprise fewer or more components than those shown in the figures while not departing from the scope of the disclosure.

Generally, in a work environment, it may be desirable for a worker to perform workflow tasks (e.g., picking an item, lifting a box, placing, or shifting an object, perform maintenance & inspection of an asset, etc.) with required safety and efficiency. In an example embodiment, the worker for performing a workflow operation may utilize a wearable electronic device (such as a headset) and a mobile device (for example, a handheld computer or a portable computer). The workflow operation may comprise lifting a heavy object which may be unsafe for the worker. Further, the worker performing a task might be unaware of nearby dangerous situations such as a wet floor, a freezer area, etc. and this might be risky to the worker. Moreover, the worker might be unaware or ignorant of type of equipments or machines to be used while performing the allocated task. Thus, a system employed with sensors may determine if the worker is working in a safe environment. For example, sensors mounted in premises at strategic locations, or sensors associated with the worker or another worker may monitor if the worker (while performing the tasks) follows proper ergonomics and is working in the safe environment. Based on sensed data from the sensors, the system may provide real-time feedback and assistance to the worker. In some examples, the sensors (such as a camera or an imaging device) associated with a second worker may capture images of a first worker performing the tasks. The captured images may be utilized to provide the real-time feedback and assistance to the first worker.

In an alternate example embodiment, it may be desirable to warn the worker that he is approaching towards an uncertain dangerous situation. The sensed data or sensor readings may be utilized by the system to alert the worker. Furthermore, the system may provide an assistance to the worker to carry special equipments that might be needed during a task execution. In this way, the time taken by the worker to grab the required equipment at the time of task execution may be eliminated. The system may provide the assistance to the worker in real-time, thereby, enhancing the safety and improving an efficiency of the worker. In one example, the real-time assistance to the worker may include instructions or suggestions to wear required PPE (personal protective equipments) such as gloves, hat, shoes, etc. In this way, safety of the worker may be ensured by the system.

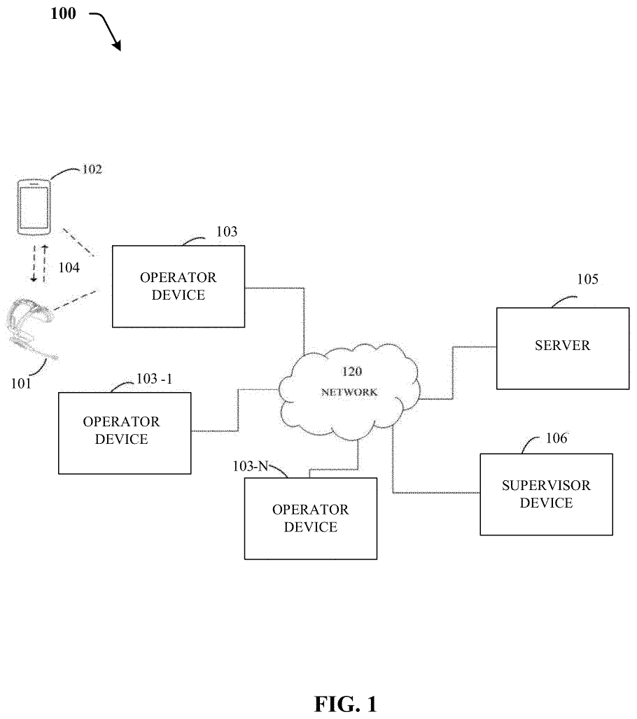

Typically, a company may perform regular inspections of its equipment and systems to ensure proper operability of business assets for the overall health, compliance, and productivity of the company. For example, a trucking company may regularly perform inspections that are required for compliance with interstate commerce laws. A truck inspection may include the steps of checking lights, a braking system, a steering system, an emission system, and other equipment. Thus, it may desirable to monitor a performance of the worker (hereafter referred as an inspector) performing the given task, for example, an inspection task. Further, the inspector performing the inspection might need help from an expert or a supervisor. Therefore, the present disclosure provides a real-time assistance and training system for helping the inspector as well as monitoring the performance of the inspector. An expert advice and live feedbacks may be provided to the inspector to facilitate real-time training to the inspector when the task is in progress. In this way, the overall efficiency of the inspector can be improved. Details of various example embodiments for providing the real-time assistance, are described in reference to FIGS. 1-13 hereinafter.

The term “electronic device” used hereinafter refers to any or all of, handheld devices, mobile phones, wearable devices, personal data assistants (PDAs), tablet computers, smart books, palm-top computers, barcode readers, scanners, indicia readers, imagers, Radio-frequency identification (RFID readers or interrogators), vehicle-mounted computers, wearable barcode scanners, wearable indicia readers, a point of sale (POS) terminal, headset devices, programmable logic controllers (PLC s), programmable automation controllers (PACs), industrial computers, laptop computers, desktop computers, personal computers, and similar electronic devices equipped with at least a processor configured to perform the various operations described herein.

The term “electronically coupled,” “coupled”, “electronically coupling,” “electronically couple,” “in communication with,” “communicatively coupled,” or “connected” in the present disclosure refers to two or more components being connected (directly or indirectly) through wired means (for example but not limited to, system bus, wired Ethernet) and/or wireless means (for example but not limited to, Wi-Fi, RFID technologies, Bluetooth, ZigBee, or cellular communication), such that data and/or information may be transmitted to and/or received from these components.

The term “AI (Artificial Intelligence) based model”, “trained model”, “model”, “predefined model” in the present disclosure refers to a program that has been trained on a set of data (called the training set) to recognize certain types of patterns. This model can be referred as a predefined trained dataset against which the present inputs are compared for decision making.

The term “expert system” in the present disclosure refers to a computer system, any program, or any computing device that uses AI technology for emulating the decision-making ability of a human expert.

The various embodiments are described herein using the term “computing platform” or “master device” used interchangeably for the purpose of brevity. The term “computing platform” can be used herein to refer to any computing device or a distributed network of computing device capable of functioning as a server, such as a master exchange server, web server, mail server, document server, or any other type of server. A computing platform may be a dedicated computing device or a computing device including a server module (e.g., running an application which may cause the computing device to operate as a server). A server module (e.g., server application) may be a full function server module, or a light or secondary server module (e.g., light or secondary server application) that is configured to provide synchronization services among the dynamic databases on computing devices. A light server or secondary server may be a slimmed-down version of server type functionality that can be implemented on a computing device, such as a smartphone, thereby enabling it to function as an Internet server (e.g., an enterprise e-mail server) only to the extent necessary to provide the functionality described herein.

In some example embodiments, the computing platform may correspond to any of, an industrial computer, a cloud computing-based platform, an external computer, a host computer, a standalone computing device, and/or the like. In some example embodiments, the master device, or the computing platform, can also refer to any of the electronic devices, as described herein. In some example embodiments, the computing platform may include an access point or a gateway device that can be capable of communicating directly with one or more electronic devices and can also be capable of communicating (either directly or alternatively indirectly via a communication network such as the Internet) with a network establishment service (e.g. Internet service provider). In some example embodiments, the computing platform can refer to a server system that can manage the deployment of one or more electronic devices throughout a physical environment. In some example embodiments, the computing platform may refer to a network establishment service including distributed systems where multiple operations are performed by utilizing multiple computing resources deployed over a network and/or a cloud-based platform or cloud-based services, such as any of a software-based service (SaaS), infrastructure-based service (IaaS) or platform-based service (PaaS) and/or like.

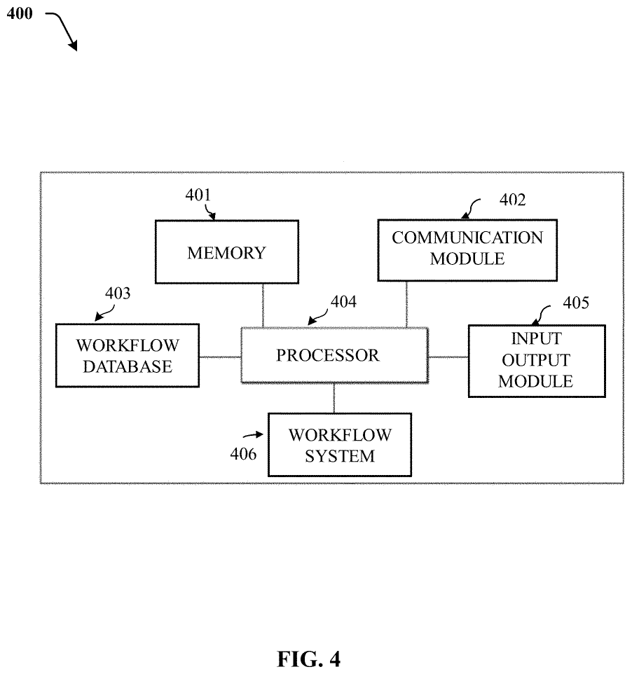

Referring now to FIG. 1, illustrated is a workflow performance system 100 including an example network architecture for a system, which may include one or more devices and sub-systems that can be configured to implement some embodiments discussed herein. For example, workflow performance system 100 can include server 105, which can include, for example, the circuitry disclosed in FIGS. 4, and 12-13, a server, or database, among other things (not shown). The server 105 may include any suitable network server and/or other type of processing device. In some embodiments, the server 105 may receive requests and transmit information or indications regarding such requests to operator devices 103-103N and/or one or more supervisor devices 106. The operator devices 103-103N referred herein can correspond to electronic devices that may be used by operators (e.g. workers) in a work environment while performing various tasks. Further, the supervisor devices 106 referred herein can correspond to electronic devices used by a supervisor or an administrator in the work environment. In an example, the work environment can correspond to a warehouse, inspection sites, distribution centers, or inventory and the supervisor can be a manager.

In some example embodiments, the server 105 can communicate with one or more operator devices 103-103N and/or one or more supervisor devices 106 via a network 120. In this regard, the network 120 may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, the network 120 may include a cellular telephone, an 802.11, 802.16, 802.20, and/or LTE network. Further, the network 120 may include a public network, such as the Internet, a private network, such as an intranet, or combinations thereof, and may utilize a variety of networking protocols now available or later developed including, but not limited to TCP/IP based networking protocols.

In some example embodiments, the network 120 can include, but are not limited to, a Wireless Fidelity (Wi-Fi) network, a Piconet, a Personal Area Network (PAN), Zigbee, and a Scatter net. In some examples, the network 120 can correspond to a short-range wireless network through which the operator devices 103-103N can communicate with each other using one or more communication protocols such as, but are not limited to, Wi-Fi, RFID technology based communication, Bluetooth, Bluetooth low energy (BLE), Zigbee, Ultrasonic frequency based network, and Z-Wave. In some examples, the network 120 can correspond to a network in which the plurality of electronic devices can communicate with each other using other various wired and wireless communication protocols such as Transmission Control Protocol and Internet Protocol (TCP/IP), User Datagram Protocol (UDP), and 2G, 3G, 4G, or 5G communication protocols. In some examples, the network 120 can correspond to any communication network such as, but not limited to, LoRA, cellular (NB IoT, LTE-M, Leaky Feeder Coax, etc.)

In some example embodiments, the operator devices 103-103N, supervisor device 106, and/or server 105 may each be implemented as a computing device, such as a personal computer and/or other networked device, such as a cellular phone, tablet computer, mobile device, point of sale terminal, inventory management terminal etc. The depiction in FIG. 1 of “N” members is merely for illustration purposes. Further, while only one supervisor device 106 is illustrated in FIG. 1, in some embodiments, multiple or a plurality of supervisor device 106 may be connected in the system. Furthermore, any number of users, operator devices and/or supervisor devices may be included in the workflow performance system 100. In one embodiment, the operator devices 103-103N and/or supervisor devices 106 may be configured to display an interface on a display of the respective device for viewing, creating, editing, and/or otherwise interacting with the server. According to some embodiments, the server 105 may be configured to display the interface on a display of the server 105 for viewing, creating, editing, and/or otherwise interacting with information on the server 105. In some embodiments, an interface of operator devices 103-103N and/or supervisor device 106 may be different from an interface of the server 105. Various components of the present system may be performed on one or more of the operator devices 103-103N, supervisor device 106, or server 105. The workflow performance system 100 may also include additional client devices and/or servers, among other things.

According to some example embodiments, the operator devices 103-103N can include, for example, but not limited to, an electronic device 102 (e.g. a mobile device, a PDA etc.) and a voice-controlled apparatus 101 (e.g. a headset device, a wearable head mounting device, a wearable electronic device etc.). In this regard, an operator in the work environment can use the electronic device 102 and/or the voice-controlled apparatus 101 to perform one or more operations in the work environment. For instance, in some example embodiments, the operator devices 103-103N can be used by operators to execute a workflow operation that can include one or more tasks. In this regard, in some examples, the workflow operation can include a sequence or series of steps to be performed by the operator. In some example embodiments, one or more steps of the workflow operation can be provided in form of voice directed instructions or graphical user interface (GUI) based instructions to the operators on the operator devices 103-103N.

As an example, in a work environment (e.g. a warehouse, an industrial environment, a distribution center, inspection sites, etc.), the operator may use the electronic device 102 that can be preconfigured with an application (e.g. a mobile application) to execute a workflow operation. For instance, in some examples, the operators can use these devices (i.e. the operator devices 103-103N, electronic devices, for example, 102) for automatic identification and data capturing of information and to improve productivity in the work environment. In some examples, the application can be used to execute various steps of the workflow operation. According to some example embodiments, the application can be installed on at least one of the electronic device 102 and the voice-controlled apparatus 101 and can be used to generate instructions for the operators at each step of the workflow operation. These instructions can be provided on the electronic device 102 and/or the voice-controlled apparatus 101.

According to some example embodiments, the voice-controlled apparatus 101 can be used to provide instructions to the operators in form of ‘voice prompts’ to perform various activities in the work environment. For instance, in an example, for a picking workflow operation, the operators can be provided instructions in form of voice prompts on the voice-controlled apparatus 101 for picking various items in an inventory. The voice prompts in such case may include instructions for the operators, like, but not limited to, ‘reach to a location of the inventory’, ‘confirm a check-digit associated with the location’, ‘identify an item from amongst several item’, ‘confirm a stock-keeping unit (SKU) associated with the item’, ‘pick the item’, ‘move to next location’, ‘perform inspection of the asset” and so on. Further, in some example embodiments, the electronic device 102 can be configured to provide instructions to the operators in visual form i.e. instructions that can be displayed on a GUI of the electronic device 102. Accordingly, the operators can perform a step of the workflow operation based on instructions provided in the voice prompt and/or visual prompt. Further, the electronic device 102 and/or the voice-controlled apparatus 101 can be configured to receive operator's response to the instructions. For instance, as the operators perform the task, the operators can provide a ‘voice response’ and/or a GUI input based response on the voice-controlled apparatus 101 and/or the electronic device 102, respectively.

Illustratively, the operator devices 103-103N can be communicatively coupled over the network 120. Similarly, in accordance with some example embodiments, the electronic device 102 can be communicatively coupled to the voice-controlled apparatus 101 via the network 120. As an example, the voice-controlled apparatus 101 can be communicatively coupled to the electronic device 102 over a Bluetooth communication based network. In this regard, the electronic device 102 can exchange data and various commands with the voice-controlled apparatus 101 using the Bluetooth network.

In some examples, voice-based instructions and visual-based instructions of the task of the workflow can be provided to the operator devices 103-103N that may comprise of the voice-controlled apparatus 101 and the electronic device 102. The operator device 103-103N may be worn by the worker or other user/operator, thereby allowing for hands-free operation.

In another example, voice-based instructions and visual-based instructions of the task of the workflow can be provided to simultaneously on the voice-controlled apparatus 101 and the electronic device 102, respectively. In this regard, a state of execution of workflow on the electronic device 102 and/or the voice-controlled apparatus 101 can be synchronized such that, either of a voice response and/or the GUI based input can be provided by the operator in response to the voice prompt and/or visual instruction for a same step of workflow operation to cause the workflow operation to move to a next state on both the voice-controlled apparatus 101 and the electronic device 102.

According to some example embodiments, the operator devices 103-103N can receive a file including one or more workflows that are to be executed on the operator device 103-103N. In this regard, according to some example embodiments, the workflow operation can be executed on the operator devices 103-103N (e.g., the electronic device 102 and/or the voice-controlled apparatus 101) based on exchange of messages between the devices. In some example embodiments, the operator devices 103-103N can receive the file including the one or more workflows from the server 105.

According to some example embodiments, the electronic device 102, the voice-controlled apparatus 101, the operator devices 103-103N, the supervisor device 106, and/or the server 105 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, the operator devices 103-103N, the supervisor device 106, and/or the server 105 may include one or more output devices, including but not limited to a display, a speaker, a haptic feedback mechanism, a printer, lights, any other mechanism capable of presenting an output to a user, or any combination thereof.

The operator devices 103-103N, supervisor device 106, and/or server 105 may include components for monitoring and/or collecting information regarding the user or external environment in which the component is placed. For instance, the operator devices 103-103N, supervisor device 106, and/or server 105 may include sensors, scanners, and/or other monitoring components. In some embodiments, scanners may be used to determine the presence of certain individuals or items. For example, in some embodiments, the components may include a scanner, such as an optical scanner, RFID scanner, and/or other scanner configured to read human and/or machine readable indicia physically associated with an item.

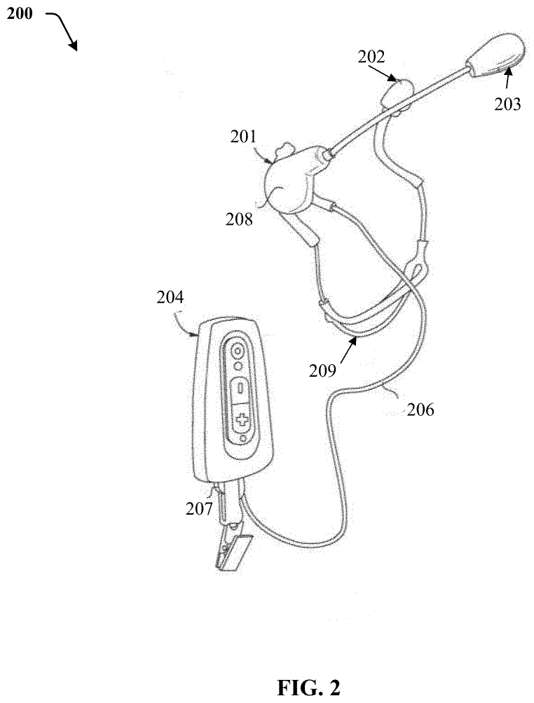

FIG. 2 illustrates an exemplary voice-controlled apparatus 200 according to an example embodiment. In the embodiment illustrated in FIG. 2, the voice-controlled apparatus 200 can correspond to a headset that can include a wireless enabled voice recognition device that utilizes a hands-free profile.

In accordance with some example embodiments, the headset may be substantially similar to the headset disclosed in U.S. Provisional Patent Application No. 62/097,480 filed Dec. 29, 2014, U.S. Provisional Patent Application No. 62/101,568, filed Jan. 9, 2015, and U.S. patent application Ser. No. 14/918,969, and the disclosures therein are hereby incorporated by reference in their entireties.

In accordance with an example embodiment, as illustrated, the voice-controlled apparatus 200 can include an electronics module 204. In this embodiment, some elements can be incorporated into the electronic module 204 rather than a headset 201, to provide a long battery life consistent with long work shifts. As an example, one or more components of circuitry may be incorporated in the electronics module 204 and/or the headset 201. In some example embodiments, the electronics module 204 can be remotely coupled to a light-weight and comfortable headset 201 secured to a worker head via a headband 209. In some example embodiments, the headband 209 can be a band that is designed to fit on a worker's head, in an ear, over an ear, or otherwise designed to support the headset. The headset 201 can include one or more speakers 202 and can further include one or more microphones. For instance, in the embodiment illustrated in FIG. 2, the headset 201 includes microphones 203, 208. According to some example embodiments, the microphone 208 can provide noise cancellation by continuously listening to and blocking environmental sounds to enhance voice recognition and optionally provide for noise cancellation. In some embodiments (not shown), the electronics module 204 can be integrated into the headset 201 rather than being remotely coupled to the headset 201. Various configurations of the voice-controlled apparatus 200 can be used without deviating from the intent of the present disclosure.

In some example embodiments, the electronics module 204 can be used to offload several components of the headset 201 to reduce the weight of the headset 201. In some embodiments, one or more of a rechargeable or long life battery, display, keypad, Bluetooth® antenna, and printed circuit board assembly (PCBA) electronics can be included in the electronics module 204 and/or otherwise incorporated into the voice-controlled apparatus 200.

In the embodiment illustrated in FIG. 2, the headset 201 can be coupled to the electronics module 204 via a communication link such as a small audio cable 206 but could instead communicate with the electronics module 204 via a wireless link. In an example embodiment, the headset 201 can be of a low profile. For instance, the headset 201 can be minimalistic in appearance in some embodiments, such as a Bluetooth earpiece/headphone.

According to some example embodiments the electronics module 204 can be configured to be used with various types of headsets 201. In some example embodiments, the electronics module 204 can read a unique identifier (I.D.) of the headset 201, which can be stored in the circuitry of the voice-controlled apparatus 200 and can also be used to electronically couple the speakers and microphones to electronics module 204. In one embodiment, the audio cable 206 can includes multiple conductors or communication lines for signals which can include a speaker +, speaker −, ground digital, microphone, secondary microphone, and microphone ground. In some examples, the electronics module 204 can utilize a user configurable attachment 207, such as a plastic loop, to attach to a user. For instance, in the embodiment illustrated in FIG. 2, the electronics module 204 can be mounted to a worker torso via a lapel clip and/or lanyard. When a wireless link between the headset 201 and electronics module 204 is used, such as a Bluetooth type of communication link, the headset 201 can include a small lightweight battery. The communication link can provide wireless signals suitable for exchanging voice communications.

In some embodiments, voice templates for performing a speaker dependent training of a speech recognition model can be stored locally in the electronics module 204 and/or the headset 201 as part of the circuitry 200 to recognize a user's voice interactions and may convert the interaction into text based data and commands for interaction with an application running in the circuitry 200. For example, the voice-controlled apparatus 200 can perform voice recognition in one embodiment utilizing the voice templates. According to some example embodiments, first few stages of voice recognition can be performed in the voice-controlled apparatus 200, with further stages performed on the server 105. In further embodiments, raw audio can be transmitted from voice-controlled apparatus 200 to the server 105 where the final stages of voice recognition can be completed. Alternatively, in some example embodiments, the voice recognition can be performed on the voice-controlled apparatus 200.

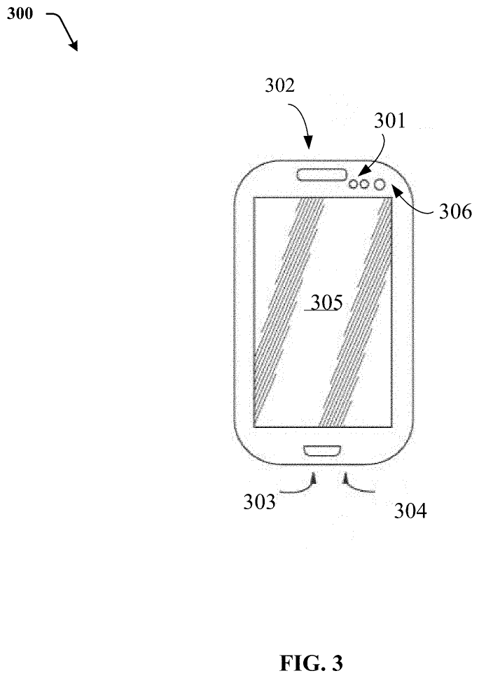

FIG. 3 illustrates an exemplary user device 302 according to an example embodiment. In the embodiment illustrated in FIG. 3, the user device may be a handset 302 (e.g., a mobile device or tablet device). The handset 302, referred as the electronic device 102 may include one or more components of circuitry as explained with regards to FIG. 1 and may include one or more of the components discussed with regards to the headset of FIG. 2 (e.g., voice templates, speech encoders, etc.). The handset 302 may include one or more microphones 303 and one or more speakers 304, which may be connected to a set of headphones. The handset 302 can also include one or more antenna. The microphone 303 receives speech or sound and transmits the received speech and sound to one or more components of circuitry 400 (to be shown in FIG. 4) in the handset 302. The speakers 304 receive an audio transmission from one or more components of circuitry 400 in the handset 302 and output the audio transmission in the form of speech or sound. In an embodiment, the speakers 304 can also include noise cancellation. The handset 302 may connect with one or more operator devices 103-103N and/or server 105 as explained with regards to FIG. 1. For instance, in some embodiments, the handset 302 may connect to a wireless headphone via a Bluetooth connection or via an NFC module, where the wireless headphone includes a microphone and speaker for receiving speech and outputting speech or sound. The handset 302 can include a speech recognizer unit to perform speech recognition of the speech input. The handset 302 can also include a user input device and output device (such as a display 305 forming an interface) to send and receive additional non-auditory information from circuitry 400, whether incorporated into the handset 302 or in other operator devices 103-103N and/or server 105. The display 305 of FIG. 3 may be a backlit LCD or OLED display. With the use of the handset 302 having one or more microphones 303 and one or more speakers 304, a user can communicate with a central server (e.g., server 105) and/or with other user devices (e.g., operator devices 103-103N).

In the embodiment illustrated in FIG. 3, the user device may include a sensor 301 configured to determine the location of the user device and an LED 306 to provide notification or alert to the user. The sensor 301 may include, but may not be limited to, an imaging sensor, an electro-optic sensor, a GPS receiver, an accelerometer, an altitude sensor, a motion sensor, a position sensor, a proximity sensor, a light sensor, and the like. In an embodiment, the sensor 301 may determine a location of the user by determining GPS coordinates of the operator devices 103-103N and/or a vehicle. The sensor 301 may communication or interact with other components of the circuitry 400, such as a processor 404, to determine whether the user is in transit, such as in transit to a desired location.

Although FIG. 3 illustrates one example of a handheld device, various changes may be made to FIG. 3. For example, all or portions of FIG. 3 may represent or be included in other handheld devices and/or vehicle communication devices and may be used in conjunction with a headset such as the headset of FIG. 2. Also, the functional division shown in FIG. 3 is for illustration only. Various components could be combined, subdivided, or omitted and additional components could be added according to particular needs.

One suitable device for implementing the present disclosure may be the TALKMAN® product available from VOCOLLECT™ of Pittsburgh, Pa. In accordance with one aspect of the present disclosure, the user device uses a voice-driven system, which may use speech recognition technology for communication. In an embodiment, the user device may provide hands-free voice communication between the user and the user device. To that end, digital information may be converted to an audio format, and vice versa, to provide speech communication between the user device or an associated system and the user. In an example embodiment, the user device may contain digital instructions or receive digital instructions from a central computer and/or a server and may convert those instructions to audio to be heard by the user. The user may then reply, in a spoken language, and the audio reply or the speech input may be converted to a useable digital format to be transferred back to the central computer and/or the server. In other embodiments, the user device may operate independently, in an offline mode, such that speech digitization, recognition and/or synthesis for implementing a voice-driven workflow solution may be performed by the user device itself.

FIG. 4 shows a schematic block diagram of circuitry 400, some or all of which may be included in, for example, the voice-controlled apparatus 101, the electronic device 102, the operator devices 103-103N, the supervisor device 106, and/or the server 105. Any of the aforementioned systems or devices may include the circuitry 400 and may be configured to, either independently or jointly with other devices in the network 120 perform the functions of the circuitry 400 described herein. As illustrated in FIG. 4, in accordance with some example embodiments, circuitry 400 can includes various means, such as a memory 401, communication module 402, processor 404, and/or input/output module 405. In some embodiments, workflow database 403 and/or workflow system 406 may also or instead be included. As referred to herein, “module” includes hardware, software and/or firmware configured to perform one or more particular functions. In this regard, the means of circuitry 400 as described herein may be embodied as, for example, circuitry, hardware elements (e.g., a suitably programmed processor, combinational logic circuit, and/or the like), a computer program product comprising computer-readable program instructions stored on a non-transitory computer-readable medium (e.g., the memory 401) that is executable by a suitably configured processing device (e.g., the processor 404), or some combination thereof.

The processor 404 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 4 as a single processor, in some embodiments the processor 404 comprises a plurality of processors. The plurality of processors may be embodied on a single computing device or may be distributed across a plurality of computing devices collectively configured to function as the circuitry 400. The plurality of processors may be in operative communication with each other and may be collectively configured to perform one or more functionalities of the circuitry 400 as described herein. In an example embodiment, the processor 404 is configured to execute instructions stored in the memory 401 or otherwise accessible to the processor 404. These instructions, when executed by the processor 404, may cause the circuitry 400 to perform one or more of the functionalities of the circuitry 400 as described herein.

Whether configured by hardware, firmware/software methods, or by a combination thereof, the processor 404 may comprise an entity capable of performing operations according to embodiments of the present invention while configured accordingly. Thus, for example, when the processor 404 is embodied as an ASIC, FPGA or the like, the processor 404 may comprise specifically configured hardware for conducting one or more operations described herein. Alternatively, as another example, when the processor 404 is embodied as an executor of instructions, such as may be stored in memory 401, the instructions may specifically configure the processor 404 to perform one or more algorithms and operations described herein, such as those discussed in connection with FIGS. 1-13.

The memory 401 may comprise, for example, volatile memory, non-volatile memory, or some combination thereof. Although illustrated in FIG. 4 as a single memory, the memory 401 may comprise a plurality of memory components. The plurality of memory components may be embodied on a single computing device or distributed across a plurality of computing devices. In various embodiments, the memory 401 may comprise, for example, a hard disk, random access memory, cache memory, read only memory (ROM), erasable programmable read-only memory (EPROM) & electrically erasable programmable read-only memory (EEPROM), flash memory, magnetic cassettes, magnetic tape, magnetic disk storage or other magnetic storage devices, a compact disc read only memory (CD-ROM), digital versatile disc read only memory (DVD-ROM), an optical disc, circuitry configured to store information, or some combination thereof. The memory 401 may be configured to store information, data (including item data and/or profile data), applications, instructions, or the like for enabling the circuitry 400 to carry out various functions in accordance with example embodiments of the present invention. For example, in at least some embodiments, the memory 401 is configured to buffer input data for processing by processor 404. Additionally, or alternatively, in at least some embodiments, memory 401 is configured to store program instructions for execution by processor 404. Memory 401 may store information in the form of static and/or dynamic information. This stored information may be stored and/or used by the circuitry 400 during the course of performing its functionalities.

The communication module 402 may be embodied as any device or means embodied in circuitry, hardware, a computer program product comprising computer readable program instructions stored on a computer readable medium (e.g., memory 401) and executed by a processing device (e.g., processor 404), or a combination thereof that is configured to receive and/or transmit data from/to another device and/or network, such as, for example, a second circuitry 400 and/or the like. In some embodiments, the communication module 402 (like other components discussed herein) can be at least partially embodied as or otherwise controlled by the processor 404. In this regard, the communication module 402 may be in communication with the processor 404, such as via a bus. The communication module 402 may include, for example, an antenna, a transmitter, a receiver, a transceiver, network interface card and/or supporting hardware and/or firmware/software for enabling communications with another computing device. The communication module 402 may be configured to receive and/or transmit any data that may be stored by the memory 401 using any protocol that may be used for communications between computing devices. The communication module 402 may additionally or alternatively be in communication with the memory 401, input/output module 405 and/or any other component of circuitry 400, such as via a bus.

The input/output module 405 may be in communication with the processor 404 to receive an indication of a user input and/or to provide an audible, visual, mechanical, or other output to a user (e.g., employee and/or customer). Some example visual outputs that may be provided to a user by circuitry 400 are discussed in connection with FIGS. 1-13. As such, the input/output module 405 may include support, for example, for a keyboard, a mouse, a joystick, a display, a touch screen display, a microphone, a speaker, a RFID reader, barcode reader, biometric scanner, and/or other input/output mechanisms. In embodiments wherein the circuitry 400 is embodied as a server or database, aspects of the input/output module 405 may be reduced as compared to embodiments where the circuitry 400 is implemented as an end-user machine (e.g., remote worker device and/or employee device) or other type of device designed for complex user interactions. In some embodiments (like other components discussed herein), the input/output module 405 may even be eliminated from circuitry 400. Alternatively, such as in embodiments wherein the circuitry 400 is embodied as a server or database, at least some aspects of the input/output module 405 may be embodied on an apparatus used by a user that is in communication with circuitry 400. Input/output module 405 may be in communication with the memory 401, communication module 402, and/or any other component(s), such as via a bus. One or more than one input/output module and/or another component can be included in circuitry 400.

The workflow database 403 and the workflow system 406 may also or instead be included and configured to perform the functionality discussed herein related to workflow and/or identifying performance status associated with an execution of the workflow. In some embodiments, some or all of the functionality of generating and/or information for workflow and/or performance status associated with execution of the workflow may be performed by processor 404. In this regard, the example processes and algorithms discussed herein can be performed by at least one the processor 404, the workflow database 403, and/or the workflow system 406. For example, non-transitory computer readable media can be configured to store firmware, one or more application programs, and/or other software, which include instructions and other computer-readable program code portions that can be executed to control each processor (e.g., processor 404, workflow database 403, and/or workflow system 406) of the components of circuitry 400 to implement various operations, including the examples shown above. As such, a series of computer-readable program code portions are embodied in one or more computer program goods and can be used, with a computing device, server, and/or other programmable apparatus, to produce machine-implemented processes.

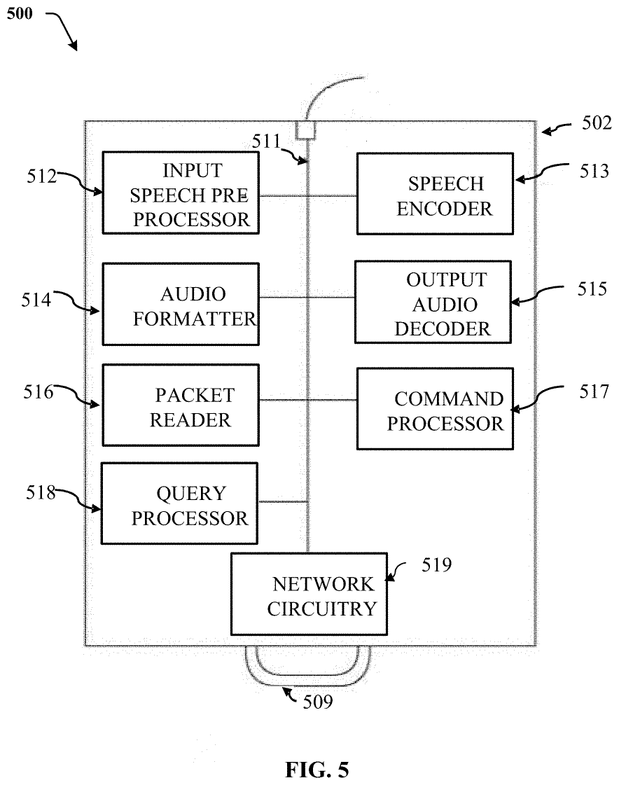

FIG. 5 illustrates an exemplary block diagram of an electronics module 502 in accordance with some embodiments of the present disclosure. The components illustrated in FIG. 5 may be in addition to one or more components of the circuitry 400 shown in FIG. 4, which may be part of the electronics module 502. In some embodiments, one or more of the components illustrated in FIG. 5 may be included in the electronics module 502 and/or other parts of the voice-controlled apparatus (200, 101), the electronic device 102, the operator devices 103-103N, the supervisor device 106, and/or the server 105.

In the embodiment shown in FIG. 5, the electronics module 502 can include an enclosure, such as plastic case, with a connector that can mate with a complimentary mating connector (not shown) on audio cable 206 (as shown in FIG. 2). An internal path 511 can be used to communicate between multiple components within the electronics module 502 enclosure. The electronics module 502 can utilize a user-configurable attachment feature 509, such as a plastic loop and/or other suitable features, for at least partially facilitating attachment of the electronics module to the worker. In one embodiment, an input speech pre-processor (ISPP) 512 can convert input speech into pre-processed speech feature data. In some examples, an input speech encoder (ISENC) 513 can encode input speech for transmission to one or more other parts of circuitry 400 for reconstruction and playback and/or recording. Further, a raw input audio sample packet formatter 514 can transmit the raw input audio to one or more other parts of circuitry 400 using an application-layer protocol to facilitate communications between the voice terminal and headset 201 as the transport mechanism. For the purposes of the transport mechanism, the formatter 514 can be abstracted to a codec type referred to as Input Audio Sample Data (IASD). An output audio decoder (OADEC) 515 decodes encoded output speech and audio for playback in the headset 201. According to some example embodiments, a raw output audio sample packet reader 516 can operates to receive raw audio packets from one or more other parts of circuitry 400 using the transport mechanism. For the purposes of the transport mechanism, this formatter 514 can be abstracted to a codec type referred to as Output Audio Sample Data (OASD). A command processor 517 can adjusts the headset hardware (e.g., input hardware gain level) under control of one or more other parts of circuitry 400. Further, in some example embodiments, a query processor 518 can allow one or more other parts of circuitry 400 to retrieve information regarding headset operational status and configuration. Further, path 511 can also be coupled to network circuitry 519 to communicate via wired or wireless protocol with one or more other parts of circuitry 400. In some examples, the ISPP 512, ISENC 513, and raw input audio formatter 514 can be sources of communication packets used in the transport mechanism; the OADEC 515 and raw output audio reader 516 can be packet sinks. The command and query processors 517, 518 are both packet sinks as well as sources (in general they generate acknowledgement or response packets).

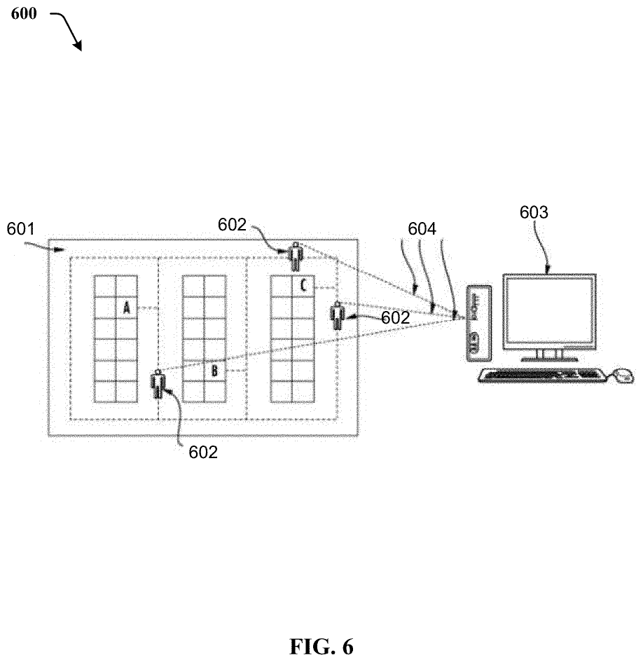

FIG. 6 graphically illustrates an exemplary implementation of a work management system, in an exemplary warehouse according to an embodiment of the present invention.

As means of example, FIG. 6 graphically depicts workers 602 performing warehouse operations in an exemplary warehouse 601. The workers 602 wear and use the operator devices 103-103N (as shown in FIG. 1) to wirelessly communicate (via voice prompts and responses) to a host computer 603 running on a software to manage the voice-enabled workflow. In some embodiment, the worker 602 may receive instructions or feedbacks from, but not limited to, the host computer 603. In another embodiment, the worker 602 can receive instructions or feedbacks either from the server 105 or the supervisor device 106 as well.

The workers 602 using the operator devices 103-103N may communicate with the host computer 603 either wirelessly or via a wired connection. Various technologies can be employed such as wireless fidelity (Wi-Fi), light fidelity (LiFi), wireless gigabit alliance (WiGig), ZigBee, Near Field Communication (NFC), magnetic secure transmission, radio frequency (RF), Ultrasound, 3G, 4G, or 5G mm wave technology, etc.

In another embodiment, the workers 602 using the operator devices 103-103N can receive information from the host computer 603 over a network. The network can include any wired or wireless communication network including cellular telephone, an 802.11, 802.16, 802.20, and/or WiMax network.

The workers 602 in the warehouse, shown in FIG. 6, participate in a voice dialog to perform work tasks. As mentioned, the voice dialog typically includes the prompts generated by the host computer 603 and responses uttered by the worker 602. By way of example, consider the following exemplary portion of a voice dialog corresponding to FIG. 6:

Operator device: “Go to room 1, aisle 2, slot 2” (i.e., location “A”);

Worker: “331” (i.e., check-digit to confirm location);

Operator device: “Pick two.”;

Worker: “Two” (i.e., confirms pick task);

Operator device: “Go to aisle 3, slot 5” (i.e., location “B”);

Worker: “225”;

Operator device: “Pick three.”;

Worker: “3”;

Operator device: “Go to aisle 4, slot 1. Pick up item X using forklift” (i.e., location “C”).

Worker: “Reached, picked up item X”.

In an exemplary embodiment, the worker 602 performing the workflow operation may be monitored by the host computer 603 to check if the workflow operation is being performed correctly, and/or the worker 602 is performing the workflow operation with given instructions or not. The host computer 603 may include a tasking module for transmitting specific task data (e.g., picking instructions, training information, scheduling information, or other information associated with a request for the worker to perform some task or provide some information) to the operator device 103-103 N or the electronic device 102. For example, the host computer 603, the server 105, or the supervisor device 106 may provide voice instructions to the worker 602 to go to a specific location and perform the task, such as “Go to aisle 3, slot 5” and “Pick three”. The worker 602 in response speaks the check digits “225” and confirms the pick operation.

Further, the picking operation here in may be monitored by the host computer 603 by using sensors. The sensors may be mounted at strategic locations within the warehouse 601. In some examples, the sensors may be associated with the body of the workers 602 or may be associated with any of the device/machine being used by the worker 602, for example, sensors present in the user device 302 or within the operator device 103-103N. In some instances, the sensors may be mounted on a vehicle in-use by the worker. As explained earlier, the sensors 301 may include, but may not be limited to, an imaging sensor, an electro-optic sensor, a GPS receiver, an accelerometer, an altitude sensor, a motion sensor, an environment sensors, a position sensor, a proximity sensor, a light sensor, and the like.

In an embodiment, the sensors may determine a location of the worker 602 by determining GPS coordinates of the operator devices 103-103N and/or a vehicle. In another embodiment, the sensors may be a camera configured to capture real-time images of the worker 602 and send it to the host computer 603. In some examples, the sensor data may be received by the operator device 103-103N or the electronic device 102 and transmitted to the host computer 603 either directly or via the network, a gateway or an access point. As already discussed, the operator devices 103-103N and the host computer 603 may communicate to each other either wirelessly or via a wired connection, for example, via 5G technology. The 5G technology herein facilitates transmission of high resolution real-time images and high volume sensor data to the host computer 603.

The host system 603 monitors the performance of the worker 602 based on comparing the received sensor data with a predefined ergonomic profile. If the sensor data matches with the predefined ergonomic profile, the host system 603 indicates that the worker 602 is following a standard performance behavior. The standard performance behavior herein refers to the worker 602 performing the task correctly with the given instructions and/or using the required safety equipments. Further, the standard performance behavior may indicate that the worker 602 is performing the task in a standardized manner. If the sensor data does not match with the predefined ergonomic profile, the host system 603 indicates that the worker 602 is following an improper performance behavior. In case of such determination of the improper performance behavior, a notification or a real-time feedback may be sent to the worker 602, thereby flagging the improper behavior of the worker.

For example, motion sensors sense movement patterns and an orientation of the worker 602. The movement patterns of the worker 602 may be analyzed by the host computer 603 to monitor the performance behavior of the worker 602 by comparing the movement patterns with the predefined ergonomic profile. The predefined ergonomic profile may consist of a set of patterns in compliance with a proper ergonomic behavior. In some examples, an imaging sensor may capture the images of the worker 602 to determine if the worker 602 is wearing required PPE while performing the task.

In yet another example embodiment, the predefined ergonomic profile indicates a proper lifting technique to be used by an individual while performing a lifting operation of a heavy object. The host computer 603 may compare the movement patterns with the predefined ergonomic profile to determine an improper lifting technique being used by the worker 602. A mismatch between the movement patterns of the worker 602 and the predefined ergonomic profile indicates that the worker 602 might be using the improper lifting technique. In response to this determination, the host computer 603 flags this behavior to the worker 602 by generating and sending the real-time feedback to the worker 602 via the operator devices 103-103 N or the electronic device 102. The real-time feedback may be given to the worker 602 by sending a visual or audio alert to the operator devices 103-103N. The audio alert sent to the worker 602 may be played to the worker 602 via the speaker of the operator devices 103-103N. Additionally, the visual alert may also be displayed on the display of the operator devices 103-103N. Furthermore, in some examples, the visual alert may comprise blinking of a flashlight of a camera of the operator devices 103-103N. The real-time feedback, in some examples, may comprise sending a message to the worker 602 suggesting the worker 602 to follow the proper performance behavior, for example but not limited to, follow the proper ergonomic lifting technique. In some examples, a real-time information comprising an assistance may be provided to the worker 602 so as to assist or help the worker 602 while performing the tasks. For example, the host computer 603 may provide an instruction to the worker 602 suggesting that the item to be lifted is heavy and may require a forklift or special equipments to complete the task. Further, the host computer 603 may also send notification to the supervisor device 106 regarding the worker's 602 improper performance behavior and suggest the supervisor device 106 to take corrective actions. The notification can include, but not limited to activating a LED of the supervisor device 106, playing a beep sound or audio tone, generating vibrations, flashing a display of the supervisor device 106. In some instances, the host computer 603 may also provide recommendation to the supervisor device 106 to conduct training of the worker 602.

In some instances, the feedback may not be limited to the real-time scenario but also can be time delayed. The improper performance behavior of the worker 602 may be logged or stored for providing the feedback at later period of time. The host computer 603 determines a pattern and/or count of the improper performance behavior followed by the worker 602. If the stored improper performance behavior of the worker 602 exceeds a threshold count or if the pattern of the improper performance behavior of the worker 602 repeats, the alert may be generated and sent to the supervisor device 106. Further, the retraining of the worker 602 may be scheduled by the host computer 603. The threshold count herein may refer to a minimum number of times, the improper performance behavior can be allowed for the worker. For example, if the worker 602 may be flagged more than twice a week for following the improper performance behavior, the alert may be generated. Here, the threshold count can be two and if this is exceeded, the corrective actions may be taken for the worker 602.

In another embodiment, the assistance provided to the worker 602 may be time shifted or delayed. The assistance may include instructions that are played on the operator devices 103-103 N based on the particular location or a position of the worker 602.

In yet another embodiment, the sensor data as mentioned above may be the real-time images of the worker 602 performing the task. The host computer 603 may compare the sensed data with the predefined ergonomic profile and provide an instant real-time feedback to the worker 602. The improper ergonomics of the worker 602 may be stored in a memory and may be used in future training purpose. The aggregated data from the sensors may be used to train or update the predefined ergonomic profile to identify required training or unsafe behaviors.

The host computer 603 herein may be one or more, computers having software stored thereon. The host computer 603 may be any of a variety of different computers, including both client and server computers working together and including databases and/or systems necessary to interface with multiple voice-enabled mobile terminals. The host computer 603 may be located at one facility or may be distributed at geographically distinct facilities. Furthermore, the host computer 603 may include a proxy server. Therefore, the host computer 603 is not limited in scope to a specific configuration. The host computer 603 may run one or more software programs for handling a particular task or set of tasks, such as inventory and warehouse management systems (which are available in various commercial forms). The host computer 603 may include a Warehouse Management System (WMS), a database, and a web application to facilitate the voice enabled workflow. The host computer 603 may also include software for programming and managing the individual voice-directed mobile terminals, as well as the software for analyzing the performance of workers. In some examples, the host computer 603 may be an expert system or any computing device being operated by an expert personnel.

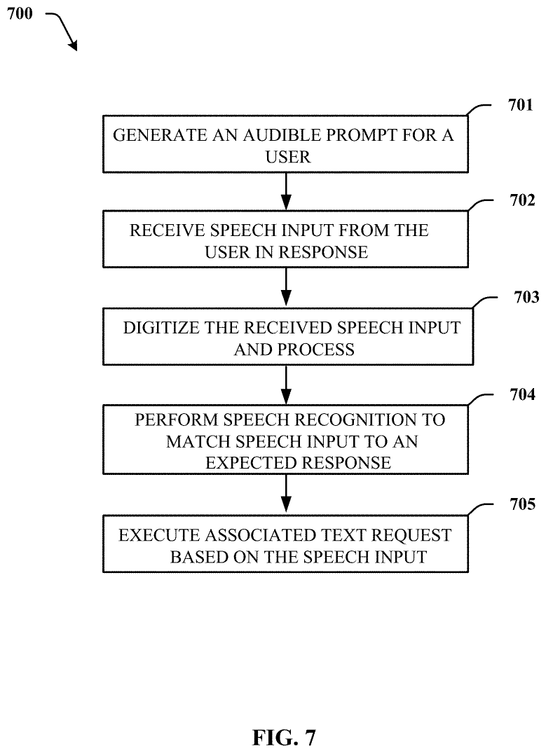

FIG. 7 illustrates an exemplary embodiment of a method 700 for providing voice-based communication and/or speech dialog between a user and an electronic device. The method 700 may include generating speech for a user, at step 701. In an embodiment, the voice-controlled apparatus (for example, 200) can include output devices, such as, speakers for receiving digital instructions and/or commands from one or more components of the circuitry in the voice-controlled apparatus and output the audio transmission in the form of speech or sound.

The method 700 can further include receiving a speech input from a user in response, at step 702. In accordance with one aspect of the present disclosure, the system can include a series of instances or junctures where an input is received from the user in response to the prompt. For example, a prompt asking a user for a desired location may request that a user provides an input, such as, speech input, providing location information, in accordance with the invention. In an example embodiment, the voice-controlled apparatus, as described above, may further include input devices, such as a microphone for receiving speech inputs from a user. The microphone may further transmit the received speech input to one or more components of circuitry in the voice controllable device for further processing and recognition.

The method 700 can include digitizing the received speech input and processing digitized speech, at step 703. In accordance with one aspect of the present disclosure, a microphone or other electro-acoustical components of the voice-controlled apparatus may receive a speech input from a user and may convert the speech input into an analog voltage signal.

The method 700 can further include performing speech recognition to match speech input to an expected response, at step 704. In accordance with one aspect of the present disclosure, a speech recognition search algorithm function, realized by an appropriate circuit and/or software in the voice controllable device may analyze the features, as described above, to determine what hypothesis to assign to the speech input captured by the microphone of the voice-controlled apparatus. As is known in the art, in one recognition algorithm, the recognition search relies on probabilistic models provided through a database of suitable models to recognize the speech input. Each of the models in the database may either be customized to a user or be generic to a set of users.

Hidden Markov Models (HMM) may be used for the speech recognition. In speech recognition, these models may use sequences of states to describe vocabulary items, which may be words, phrases, or sub word units. As used herein, the term “word” may refer to a vocabulary item, and thus may mean a word, a segment or part of a word, or a compound word, such as “next slot” or “say again.” Therefore, the term “word” may not be limited to just a single word. Each state in an HMM may represent one or more acoustic events and may serve to assign a probability to each observed feature vector. Accordingly, a path through the HMM states may produce a probabilistic indication of a series of acoustic feature vectors. The model may be searched such that different, competing hypotheses (or paths) are scored; a process known as acoustic matching or acoustic searching. A state S may be reached at a time T via a number of different paths. For each path reaching a particular state at a particular time, a path probability may be calculated. Using the Viterbi algorithm, each path through the HMM may be assigned a probability. In particular, the best path may be assigned a probability. Furthermore, each word in the best path may be assigned a probability. Each of these probabilities may be used as a confidence factor or combined with other measurements, estimates or numbers to derive a confidence factor. The path with the highest confidence factor, the best hypothesis, can then be further analyzed.

When in operation, the search algorithm (which can be implemented using Hidden Markov Models with a Viterbi algorithm or other modeling techniques such as template matching dynamic time warping (DTW) or neural networks), in essence, may compare the features generated, as described above, with reference representations of speech, or speech models, in the database in order to determine the word or words that best match the speech input from the user device. In an embodiment, part of this recognition process may be to assign a confidence factor for the speech to indicate how closely the sequence of features from the search algorithm matches the closest or best-matching models in the database. As such, a hypothesis consisting of one or more vocabulary items and associated confidence factors may be directed to an acceptance algorithm to determine expected response. In accordance with the above embodiment, if the confidence factor is above a predetermined acceptance threshold, then the acceptance algorithm may decide to accept the hypothesis as recognized speech. If, however, the confidence factor is not above the acceptance threshold, as utilized by the acceptance algorithm, then the acceptance algorithm may decide to ignore or reject the recognized speech. The user device may then prompt the user to repeat the speech input. In this instance, the user may repeat the audio input provided to the microphone.

The method 700 may further include executing the text request associated with the speech input, at step 705. That is, a text request may be associated with the recognized speech and then acted upon after processing the speech input.

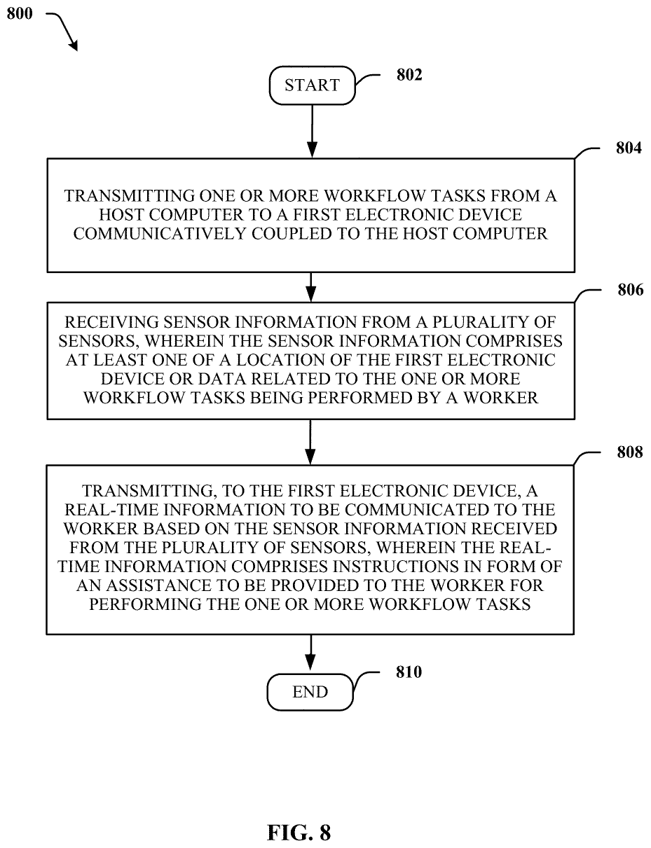

FIG. 8 illustrates a flow diagram representing a method 800 for providing real-time information to a first electronic device (can be, but not limited to, the operator devices 103-103N, the electronic device, or the user device 302), in accordance with an example embodiment described herein.

The method 800 starts at step 802.

At step 804, a host computer (e.g. the host computer 603 or the server 105) may transmit one or more workflow tasks to the first electronic device (for example, but not limited to the operator devices 103-103N) communicatively coupled to the host computer. The host computer may communicate with the first electronic device either wirelessly (for example, using 3G, 4G, or 5G mm wave technology) or via a wired connection. In this regard, as described earlier in FIG. 6, the host computer 603 may comprise of the tasking module for transmitting specific task data (e.g., picking instructions, training information, scheduling information, or other information associated with a request for the worker to perform some task or provide some information) to the operator devices 103-103 N or the electronic device 102. The worker (for example, the workers 602) may use the first electronic device such as the operator devices 103-103N to execute the workflow tasks.

At step 806, the host computer receives sensor information from a plurality of sensors. In an example, as described in FIG. 6, the plurality of sensors can be any of a motion sensor, accelerometer, gyroscope, imager, or camera, or any of the combination thereof. Further, the sensors may be mounted at the strategic locations within the warehouse 601 or can be associated with the worker, or in some instances, may be present in the operator devices 103-103N. The sensor information comprises at least one of a location of the first electronic device or data related to the one or more workflow tasks being performed by a worker. In some embodiment, the sensor information may be transmitted to the host computer in real-time or near real-time when the task is being performed by the worker. In another embodiment, the sensor information may be transmitted to the host system after the completion of the workflow tasks by the worker.

The host system may receive the sensor information either directly from the sensors or via the network employing any of the wireless communication protocol. Various technologies can be employed such as wireless fidelity (Wi-Fi), light fidelity (LiFi), wireless gigabit alliance (WiGig), ZigBee, Near Field Communication (NFC), magnetic secure transmission, radio frequency (RF), Ultrasound, 3G, 4G, or 5G mm wave technology, etc. In some examples, the network can correspond to any communication network such as, but not limited to, LoRA, cellular (NB IoT, LTE-M, Leaky Feeder Coax, etc.)

At step 808, the host computer, based on the received sensor information, may transmit real-time information to the first electronic device. The real-time information may be displayed to the worker who is using the first electronic device to perform the tasks. The relaying of the real-time information to the worker may not be limited to display. In some embodiments, the real-time information may be provided to the worker via the voice commands (through the headset 201). The real-time information may comprise instructions in form of an assistance to be provided to the worker for performing the one or more workflow tasks, for example, directing the worker to use a special equipment, warning the worker of upcoming dangerous situation, or suggesting the worker to comply with safety requirements, or providing safety suggestions to the worker.

At step 810, the process flow ends.

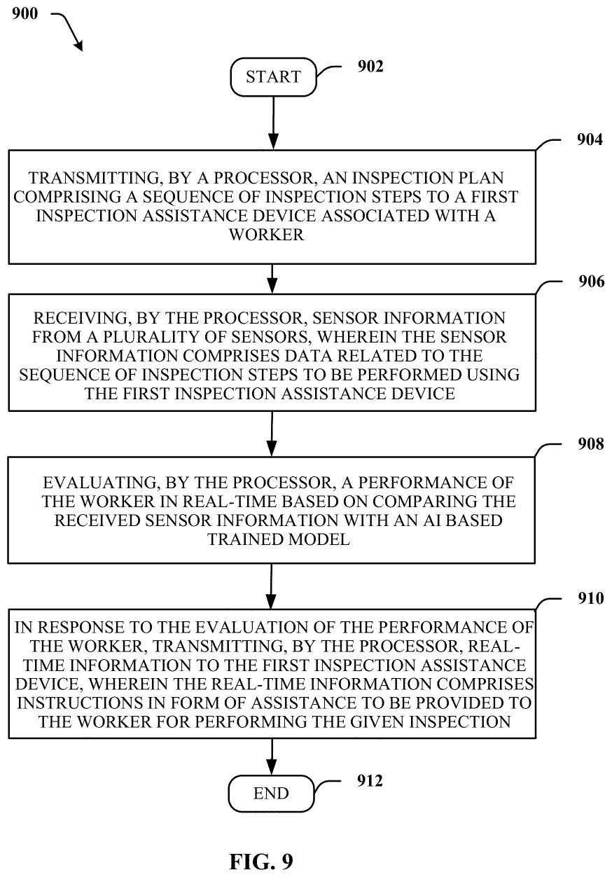

FIG. 9 illustrates a flow diagram representing another method for providing real-time information to a first inspection assistance device, in accordance with another example embodiment described herein.

The process flow starts at step 902.

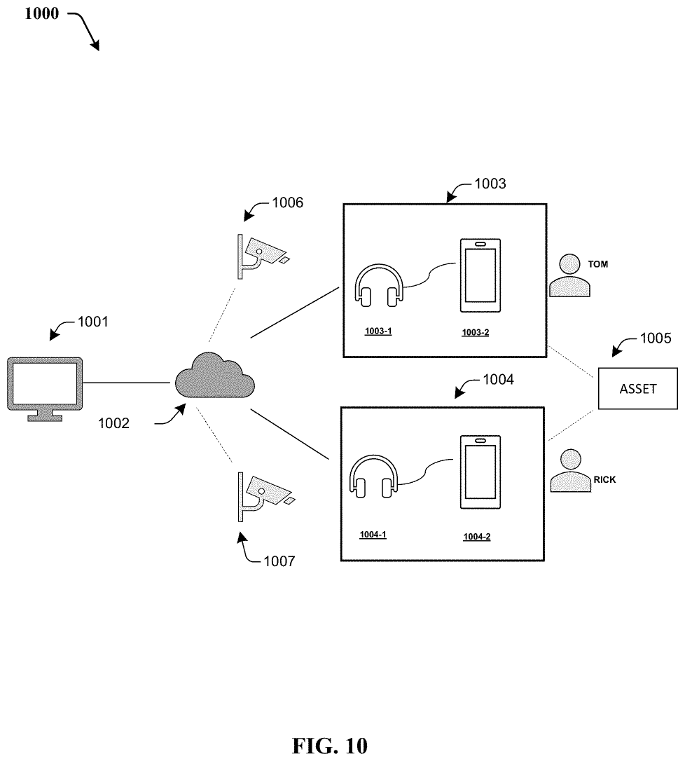

At step 904, the method illustrates that the host computer (for example, e.g. the host computer 603 or the server 105) or the supervisor device 106 may transmit an inspection plan to a first inspection assistance device (to be denoted as 1003 or 1004 in FIG. 10). The inspection plan may include a sequence of inspection steps to be performed by the worker to perform an inspection of an asset (to be referred as 1005 in FIG. 10). The asset may be a machine, a ship, or a building etc. The term inspection step defines a sequences of steps to be followed to perform inspection of the asset. The first inspection assistance device may be any device aiding the worker to perform the inspection. For example, the first inspection assistance device may be any of the operator device 103-103N, or the user device 302. The inspection plan received by the first inspection assistance device may be displayed to the worker through a GUI of the first inspection assistance device or may be issued to the worker through voice commands.

At step 906, the host computer receives the sensor information from the plurality of sensors, already described in FIG. 8. In some embodiment, the sensor information may be received by the host computer in real-time or near real-time when the inspection is being performed by the worker. In another embodiment, the sensor information may be received by the host system after the completion of each step of the inspection plan by the worker. The sensor information may comprise information related to the inspection steps. For example, the sensor may be a camera capturing real-time images of the worker performing the inspection by following the inspection steps being given to the worker via the first inspection assistance device. These real-time images may be transmitted to the host system for further processing.

The host computer may communicate with the sensors and/or the first inspection assistance device using any of the mentioned communication technologies such as wireless fidelity (Wi-Fi), light fidelity (LiFi), wireless gigabit alliance (WiGig), ZigBee, Near Field Communication (NFC), magnetic secure transmission, radio frequency (RF), Ultrasound, 5G mm wave technology, etc.

At step 908, the host system may evaluate a performance of the worker based on the received sensor information. The step of evaluation comprises comparing the sensor information with an AI based trained mode. The AI based trained model and the evaluation step will be described in greater detail, in FIG. 10.

At step 910, in response to the evaluation of the performance of the worker, the host system transmits a real-time information to the first inspection assistance device. The real-time information comprises instructions in form of assistance to the worker. For example, the worker inspecting a steering gear of a ship might not be performing inspection correctly or he might be missing out the inspection steps, the sensors capturing this information in real-time may be transmitted to the host system so as to take corrective actions. The host system on analyzing the sensor information may provide instructions in the form of the assistance to the worker to perform the inspection correctly.

In another embodiment, the sensor information may be transmitted to the supervisor device so as to take corrective actions.

In another exemplary embodiment, in response to evaluation of the performance of the worker, the host computer may transmit real-time training instructions to the first inspection assistance device so that the worker receives a real-time training from at least one of an expert, an admin, a supervisor, or a trainer. The real-time training comprises displaying on a display of the first inspection assistance device, a live training video from the expert. In another embodiment, the real-time training may comprise a series of voice dialogs or an audible training command to be played on the first inspection assistance device to train the worker.

At step 912, the process flow ends.

FIG. 10 illustrates an example scenario depicting an inspection system 1000, in accordance with an example embodiment. The exemplary inspection system 1000 can include a host system 1001 or a server, a communication network 1002, a first inspection assistance device 1003, a second inspection assistance device 1004, an asset 1005, and sensors 1006-1007.

The host system 1001 may be capable of communicating with one or more inspection assistance devices (say, the first inspection assistance device 1003 and the second inspection assistance device 1004) either directly or alternatively indirectly via the communication network 1002. The communication network may be any type of wide area network (WAN), such as the Internet, Local Area Network (LAN), or the like, or any combination thereof, and may include wired components, such as Ethernet, wireless components, such as LTE, Wi-Fi, Bluetooth™, or near field communication (NFC), or both wired and wireless components. Various other technologies can be employed here such as light fidelity (LiFi), wireless gigabit alliance (WiGig), ZigBee, magnetic secure transmission, radio frequency (RF), Ultrasound, 3G, 4G, 5G mm wave technology, etc.

Each inspection assistance device (say, a first inspection assistance device 1003 and a second inspection assistance device 1004) includes at least a headset (a first headset 1003-1 and a second headset 1004-1) and a portable electronic device (a first portable electronic device 1003-2 and a second portable electronic device 1004-2). The portable electronic devices can be referred similar to the operator devices 103-103N, as explained earlier. The host system 1001 communicates with the first inspection assistance device 1003 and the second inspection assistance device 1004 to assign an inspection task of an asset 1005. As already mentioned, the asset 1005 here refers to any of a machine, equipment, vehicle, building, ship, aero plane, etc. In some examples, the host system 1001 may transmit a sequence of inspection steps of the inspection to the first inspection assistance device 1003 and the second inspection assistance device 1004. Thus, the workers (Tom and Rick, as shown in Figure) carrying the first inspection assistance device 1003 and the second inspection assistance device 1004 respectively may perform the inspection by following the given inspection steps.

The first portable electronic device 1003-2 and the second portable electronic device 1004-2 can communicate with the first headset 1003-1 and the second headset 1004-1 respectively via at least one of a Bluetooth connection, BLE, wireless fidelity (Wi-Fi), light fidelity (LiFi), wireless gigabit alliance (WiGig), ZigBee, Near Field Communication (NFC), magnetic secure transmission, radio frequency (RF), Ultrasound, 5G mm wave technology, etc.

In one embodiment, the inspections steps may be transmitted to the first inspection assistance device 1003 and the second inspection assistance device 1004 via voice prompts. For example, the host system 1001 may issue voice commands to the first inspection assistance device 1003. The inspection steps received by the first portable electronic device 1003-2 may comprise of a speech module (not shown in figure) that translates textual inspection steps into speech form that the worker can understand. The speech module may use other methods for conversion to speech, such as processing digital audio signals and converting to analog speech. The speech module may include a TTS (text-to-speech engine) capable of converting text commands into speech signals. Further, the the first portable electronic device 1003-2 may convert the worker's speech or responses received from a mic of the first headset 1003-1 into output text data to be sent back to the host system 1001. The text-to-speech and speech to text conversion described for the first portable electronic device 1003-2 is analogous to the second portable electronic device 1004-2 as well.

In some embodiments, the host system 1001 itself may comprise of a module that translates textual instructions corresponding to the inspection plan into a digital audio signal to be played by the first portable electronic device 1003-2.

The worker (for example, Tom) may carry the first inspection assistance device 1003 to perform the said inspection and receive the inspection steps from the host system 1001. The voice commands corresponding to the inspection steps may be played to the worker Tom via a speaker of the first headset 1003-1. The worker Tom while performing the inspection or after inspection may send an audible update to the host system 1001. The audible update may indicate task completion update or an assistance request. The worker Tom may send inspection results to the host system 1001 after completion of each step of inspections. While the inspection task is being performed, the sensors 1006-1007 (for example, imaging device such as a camera) may monitor the worker Tom and send the real-time information to the host system 1001 either directly or via the communication network 1002.

As explained earlier, the sensors 1006-1007 may be mounted at strategic locations within the warehouse. In some examples, the sensors may be associated with the body of the worker Tom or may be associated with any of the device being used by the worker Tom, for example, sensors present in the first inspection assistance device 1003 or within the first portable electronic device 1003-2. In some instances, the sensors 1006-1007 may be mounted on a vehicle in-use by the worker Tom.

The host system 1001 on receiving the sensor information from sensors 1006-1007 may determine if the worker Tom is performing the inspection correctly by comparing the sensor information with an AI based trained model. The AI based trained model is a model consisting of a predefined set of performance parameters against which the inputs are compared to determine performance of a worker. In some instances, the AI based trained model refers to a model developed based on an expert's inspection results. Further, the AI based trained model may be trained dynamically based on the aggregated sensor information. In one exemplary embodiment, the AI based trained model may be trained or updated based on the worker's real-time feedbacks and observations recorded by the host system 1001, when the inspection is in progress.

In response to determining that the sensor information of the worker Tom mismatches with the AI based trained model, the host system 1001 may provide a real-time information to the first inspection assistance device 1003. Further, the host system 1001 may generate a performance rating of the worker Tom indicating task completion quality (task here means performing inspection of the asset 1005) or time taken to complete the task, and/or worker's behavior.

In yet another embodiment, the host system 1001 may provide real-time assistance to the worker Tom in response to receiving the assistance request from the first inspection assistance device 1003. The real-time assistance may include receiving queries from the worker Tom and providing appropriate responses to the first inspection assistance device 1003.

In another embodiment, the host system 1001 may provide a real-time training to the worker Tom via the first inspection assistance device 1003 from an expert, an admin, or a supervisor. The real-time training may comprise displaying on a display of the first inspection assistance device 1003, a live training video from the expert. Further, the real-time training may include providing a live AR (Augmented Reality), VR (Virtual reality) or MR (Mixed reality) based training from the expert. This can be done by bringing a part of the asset (under inspection) in field of view of an imaging device of the first inspection assistance device 1003. The expert may observe the images of the asset part and accordingly, provide assistance or training. This may help the worker Tom to improve productivity and efficiency.

In another embodiment, the performance ratings generated for workers, for example, Tom or Rick may be displayed in a dashboard of the host system 1001, the server 105 or the supervisor device 106 as a performance metric table to monitor the performance of the workers all at once. Further, the supervisor may decide based on the performance ratings who is performing the inspection well and who needs a training. Further, in regard to the same embodiment, the supervisor may praise the worker with best performance rating and may take corrective actions for the worst performing worker. In some cases, the performance rating of the workers may facilitate the host system 1001 to consider the sensor information of the best performing worker as a new training set for training the AI based trained model.

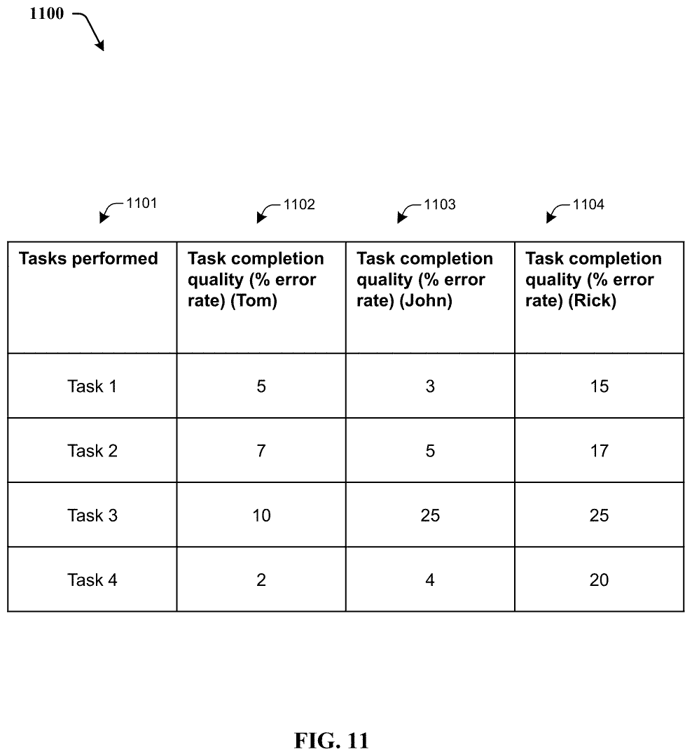

FIG. 11 illustrates an exemplary table 1100 depicting a performance metric of workers, in accordance with an example embodiment. The exemplary table 1100 includes a header row and several other rows below the header row. A first column 1101 of the exemplary table 1100 contains various exemplary tasks. A second column 1102, a third column 1103 and a fourth column 1104 contains exemplary performance rating of the workers Tom, John, and Rick respectively. The tasks here particularly refer to inspection related tasks such as tank inspection of a ship. This table may be generated at the host system 1001, the server 105 or the supervisor device 106. The table 1100 representing the performance metrics of different workers, Tom, John, and Rick may be generated based on evaluating the performance, as described in above paragraphs. Each of the task performed by the workers are evaluated against task completion quality or an error rate. In an example scenario, Tom performed task 1 with error rate of 5%, whereas John and Rick performed the same task 1 with error rate of 3% and 15% respectively. Similarly, Tom performed task 2 with error rate of 7%, whereas John and Rick performed the same task 2 with error rate of 5% and 17% respectively. Thus, the supervisor can view these metrics to decide which worker is performing good and which worker needs training. For example, Tom performed task 1 with least error rate and Rick performed the same task with higher error rate. Therefore, the supervisor may decide that Rick needs training. In some embodiment, the host system 1001 may consider Tom's performance as an input for retraining the AI based model.

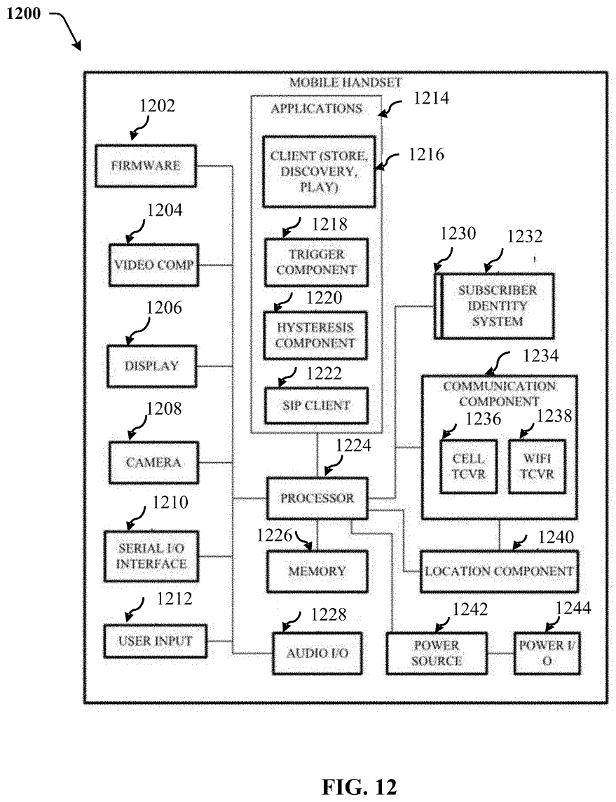

FIG. 12 illustrates a schematic view 1200 of an example electronic device (e.g. the electronic device 102, the operator devices 103-103N, the supervisor device 106 etc.), in accordance with an example embodiment described herein. In some example embodiments, the electronic device 102 can correspond to a mobile handset. FIG. 12 illustrates is a schematic block diagram of an example end-user device such as a user equipment that can be the electronic device 102 used by an operator for executing one or more tasks of a workflow.

Although, FIG. 12 illustrates a mobile handset, it will be understood that other devices can be any electronic device as described in FIG. 1, and that the mobile handset is merely illustrated to provide context for the embodiments of the various embodiments described herein. To this end, the following discussion is intended to provide a brief, general description of an example of a suitable environment in which the various embodiments can be implemented. While the description includes a general context of computer-executable instructions embodied on a machine-readable storage medium, those skilled in the art will recognize that the various embodiments also can be implemented in combination with other program modules and/or as a combination of hardware and software.

Generally, applications (e.g., program modules) can include routines, programs, components, data structures, etc., described herein in accordance with example embodiments, that can perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

According to some example embodiments, the electronic device 102, the operator devices 103-103N, and the voice-controlled apparatus 101 can typically include a variety of machine-readable media. Machine-readable media can be any available media that can be accessed by the computer and includes both volatile and non-volatile media, removable and non-removable media. By way of example and not limitation, computer-readable media can comprise computer storage media and communication media. Computer storage media can include volatile and/or non-volatile media, removable and/or non-removable media implemented in any method or technology for storage of information, such as computer-readable instructions, data structures, program modules or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

According to some example embodiments described herein, a communication media typically embodies computer-readable instructions, data structures, program modules or other data in a modulated data signal such as a carrier wave or other transport mechanism and includes any information delivery media. In this regard, the term “modulated data signal” can correspond to a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

According to some example embodiments, the mobile handset can comprise a processor 1224 for controlling and processing all onboard operations and functions. A memory 1226 interfaces to the processor 1224 for storage of data and one or more applications 1214 (e.g., a video player software, user feedback component software, etc.). Other applications can include voice recognition of predetermined voice commands that facilitate initiation of the user feedback signals. The applications 1214 can be stored in the memory 1226 and/or in a firmware 1202 and executed by the processor 1224 from either or both the memory 1226 or/and the firmware 1202. The firmware 1202 can also store startup code for execution in initializing the mobile handset. A communications component 1234 interfaces to the processor 1224 to facilitate wired/wireless communication with external systems, e.g., cellular networks, VoIP networks, and so on. Here, the communications component 1234 can also include a suitable cellular transceiver 1236 (e.g., a GSM transceiver) and/or an unlicensed transceiver 1238 (e.g., Wi-Fi, WiMAX) for corresponding signal communications. The mobile handset can be a device such as a cellular telephone, a PDA with mobile communications capabilities, and messaging-centric devices. The communications component 1234 also facilitates communications reception from terrestrial radio networks (e.g., broadcast), digital satellite radio networks, and Internet-based radio services networks.

The mobile handset can also comprise a display 1206 (e.g. display screen) for displaying text, images, video, telephony functions (e.g., a Caller ID function), setup functions, and for user input. For example, the display 1206 can also be referred to as a “screen” that can accommodate the presentation of multimedia content (e.g., music metadata, messages, wallpaper, graphics, etc.). The display 1206 can also display videos and can facilitate the generation, editing and sharing of video quotes. A serial I/O interface 1210 is provided in communication with the processor 1224 to facilitate wired and/or wireless serial communications (e.g., USB, and/or IEEE 1384) through a hardwire connection, and other serial input devices (e.g., a keyboard, keypad, and mouse). This support updating and troubleshooting the mobile handset, for example. Audio capabilities are provided with an audio 110 component 1228, which can include a speaker for the output of audio signals related to, for example, indication that the user pressed the proper key or key combination to initiate the user feedback signal. The audio 110 component 1228 also facilitates the input of audio signals through a microphone to record data and/or telephony voice data, and for inputting voice signals for telephone conversations.

The mobile handset can also comprise a slot interface 1230 for accommodating a SIC (Subscriber Identity Component) in the form factor of a card Subscriber Identity Module (SIM) or universal SIM 1232 and interfacing the SIM card 1232 with the processor 1224. However, it is to be appreciated that the SIM card 1232 can be manufactured into the mobile handset and updated by downloading data and software.

The mobile handset can also process IP data traffic through the communication component 1234 to accommodate IP traffic from an IP network such as, for example, the Internet, a corporate intranet, a home network, a person area network, etc., through an ISP or broadband cable provider. Thus, VoIP traffic can be utilized by the mobile handset and IP-based multimedia content can be received in either an encoded or decoded format.

A video processing component 1208 (e.g., a camera) can be provided for decoding encoded multimedia content. The video processing component 1208 can aid in facilitating the generation, editing, and sharing of video quotes. The mobile handset also includes a power source 1242 in the form of batteries and/or an AC power subsystem, which power source 1242 can interface to an external power system or charging equipment (not shown) by a power I/O component 1244.

According to some example embodiments, the mobile handset can also comprise a video component 1204 for processing video content received and, for recording and transmitting video content. For example, the video component 1204 can facilitate the generation, editing and sharing of video quotes. In some example embodiments, a location tracking component 1240 facilitates geographically locating the mobile handset. As described hereinabove, this can occur when the user initiates the feedback signal automatically or manually. According to some example embodiments, a user input component 1212 facilitates the user initiating the quality feedback signal. In this regard, in some examples, the user input component 1212 can also facilitate the generation, editing and sharing of video quotes. According to various example embodiments described herein, the user input component 1212 can include such conventional input device technologies such as a keypad, keyboard, mouse, stylus pen, and/or touch screen, for example.

Referring again to the applications 1214, a hysteresis component 1220 can facilitate the analysis and processing of hysteresis data, which is utilized to determine when to associate with the access point. A software trigger component 1218 can be provided that facilitates triggering of the hysteresis component 1220 when the Wi-Fi transceiver 1238 detects the beacon of the access point. A SIP client 1222 enables the mobile handset to support SIP protocols and register the subscriber with the SIP registrar server. In some example embodiments, the applications 1214 can also include a client 1216 that provides at least the capability of discovery, play and store of multimedia content, for example, music.

In some example embodiments, the mobile handset, as indicated above related to the communications component 1234, includes an indoor network radio transceiver 1238 (e.g., Wi-Fi transceiver). This function can support the indoor radio link, such as IEEE 802.11, for the dual-mode GSM handset. In some example embodiments, the mobile handset can accommodate at least satellite radio services through a handset that can combine wireless voice and digital radio chipsets into a single handheld device.

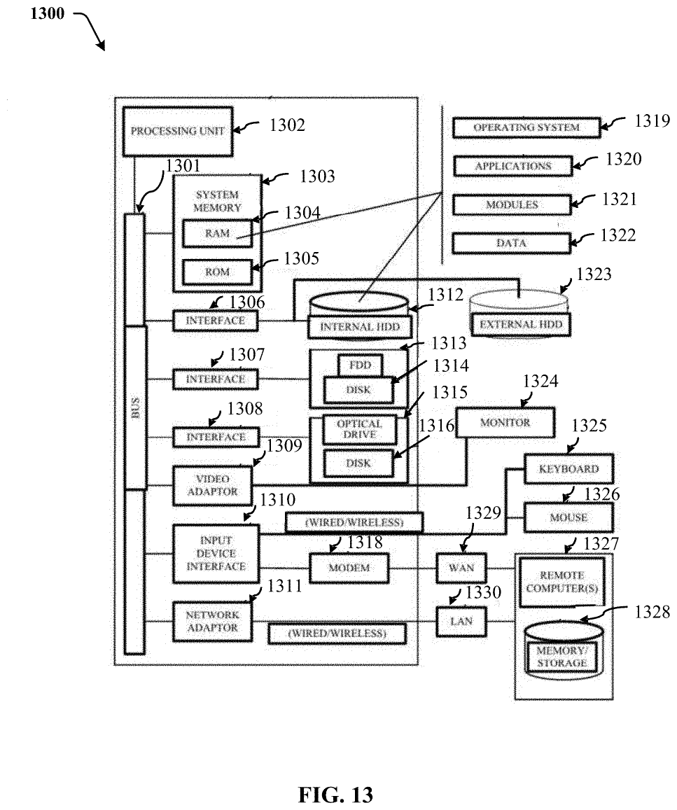

FIG. 13 illustrates a schematic view of another example of an electronic device 1300, in accordance with another example embodiment described herein. According to some example embodiments, the electronic device 1300 illustrated in FIG. 13 can correspond to the electronic device 102, the operator devices 103-103N, the supervisor device 106, and/or the server 105, as described in reference to FIGS. 1-12.

Referring now to FIG. 13, there is illustrated a block diagram of operable to execute the functions and operations performed in the described example embodiments. In some example embodiments, the electronic device 1300 can provide networking and communication capabilities between a wired or wireless communication network and a server and/or communication device. In order to provide additional context for various aspects thereof, FIG. 13 and the following discussion are intended to provide a brief, general description of a suitable computing environment in which the various aspects of the embodiments can be implemented to facilitate the establishment of a transaction between an entity and a third party. While the description above is in the general context of computer-executable instructions that can run on one or more computers, those skilled in the art will recognize that the various embodiments also can be implemented in combination with other program modules and/or as a combination of hardware and software.

According to said example embodiments, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the various embodiments can also be practiced in distributed computing environments where certain tasks are performed by remote processing devices that are linked through a communications network. In a distributed computing environment, program modules can be located in both local and remote memory storage devices.

In accordance with some example embodiments, computing devices typically include a variety of media, which can include computer-readable storage media or communications media, which two terms are used herein differently from one another as follows.

According to some example embodiments, a computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

In some examples, communications media can embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference to FIG. 13, implementing various aspects described herein with regards to the end-user device can comprise the electronic device (or referred as computing device 1300) comprising a processing unit 1302, a system memory 1303 and a system bus 1301. The system bus 1301 can be configured to couple system components including, but not limited to, the system memory 1303 to the processing unit 1302. In some example embodiments, the processing unit 1302 can be any of various commercially available processors. To this end, in some examples, dual microprocessors and other multi-processor architectures can also be employed as the processing unit 1302.

According to some example embodiments, the system bus 1301 can be any of several types of bus structure that can further interconnect to a memory bus (with or without a memory controller), a peripheral bus, and a local bus using any of a variety of commercially available bus architectures. In some examples, the system memory 1303 can comprise, read-only memory (ROM) 1305 and random-access memory (RAM) 1304. According to some example embodiments, a basic input/output system (BIOS) is stored in a non-volatile memory 1305 such as ROM, EPROM, EEPROM, which BIOS contains the basic routines that help to transfer information between elements within the computing device 1300, such as during start-up. The RAM 1304 can also comprise a high-speed RAM such as static RAM for caching data.

According to some example embodiments, the computing device 1300 can further comprise an internal hard disk drive (HDD) 1312 (e.g., EIDE, SATA), which internal hard disk drive 1312 can also be configured for external use in a suitable chassis (not shown), a magnetic floppy disk drive (FDD) 1313, (e.g., to read from or write to a removable diskette 1314) and an optical disk drive 1315, (e.g., reading a CD-ROM disk or, to read from or write to other high capacity optical media such as the DVD). In some examples, the hard disk drive 1312, magnetic disk drive 1313 and optical disk drive 1315 can be connected to the system bus 1301 by a hard disk drive interface 1306, a magnetic disk drive interface 1307 and an optical drive interface 1308, respectively. According to some example embodiments, the interface 1306 for external drive implementations can comprise, at least one or both of Universal Serial Bus (USB) and IEEE 1394 interface technologies. Other external drive connection technologies are within contemplation of the subject embodiments.

According to some example embodiments described herein, the drives and their associated computer-readable media provide nonvolatile storage of data, data structures, computer-executable instructions, and so forth. For the electronic device the drives and media accommodate the storage of any data in a suitable digital format. Although the description of computer-readable media above refers to a HDD, a removable magnetic diskette, and a removable optical media such as a CD or DVD, it may be appreciated by those skilled in the art that other types of media which are readable by an electronic device, such as zip drives, magnetic cassettes, flash memory cards, cartridges, and the like, can also be used in the example operating environment, and further, that any such media can contain computer-executable instructions for performing the methods of the disclosed embodiments.

In some example embodiments, a number of program modules can be stored in the drives and RAM 1304, including an operating system 1319, one or more application programs 1320, other program modules 1321 and program data 1322. To this end, in some examples, all or portions of the operating system, applications, modules, and/or data can also be cached in the RAM 1304. It is to be appreciated that the various embodiments can be implemented with various commercially available operating systems or combinations of operating systems.

According to some example embodiments, a user can enter commands and information into the computing device through one or more wired/wireless input devices, e.g., a keyboard 1325 and a pointing device, such as a mouse 1326. Other input devices (not shown) may include a microphone, an IR remote control, a joystick, a game pad, a stylus pen, touch screen, or the like. In some examples, these and other input devices are often connected to the processing unit 1302 through an input device interface 1310 that is coupled to the system bus 1301, but can be connected by other interfaces, such as a parallel port, an IEEE 1384 serial port, a game port, a USB port, an IR interface, etc.

According to some example embodiments, a monitor 1324 or other type of display device can also be connected to the system bus 1301 through an interface, such as a video adapter 1309. In addition to the monitor 1324, the computing device 1300 can also comprise other peripheral output devices (not shown), such as speakers, printers, etc.

According to some example embodiments, the computing device 1300 can operate in a networked environment using logical connections by wired and/or wireless communications to one or more remote computers, such as a remote computer(s) 1327. In some examples, the remote computer(s) 1327 can be a workstation, a server computer, a router, a personal computer, portable computer, microprocessor-based entertainment device, a peer device or other common network node, and typically includes many or all of the elements described relative to the computer, although, for purposes of brevity, only a memory/storage device 1328 is illustrated. According to some example embodiments, the logical connections depicted include wired/wireless connectivity to a local area network (LAN) 1330 and/or larger networks, e.g., a wide area network (WAN) 1329. Such LAN and WAN networking environments are commonplace in offices and companies, and facilitate enterprise-wide computer networks, such as intranets, all of which may connect to a global communications network, e.g., the Internet.

In some examples, when used in a LAN networking environment, the computing device 1300 can be connected to the LAN 1330 through a wired and/or wireless communication network interface or adapter 1311. The adapter 1311 may facilitate wired or wireless communication to the LAN 1330, which may also include a wireless access point disposed thereon for communicating with the wireless adapter 1311.

In alternate examples, when used in a WAN networking environment, the computing device 1300 can include a modem 1318, or can be connected to a communications server on the WAN 1329 or has other means for establishing communications over the WAN 1329, such as by way of the Internet. The modem 1318, which can be internal or external and a wired or wireless device, is connected to the system bus 1301 through the input device interface 1310. In a networked environment, program modules depicted relative to the computer, or portions thereof, can be stored in the remote memory/storage device 1328. It will be appreciated that the network connections shown are exemplary and other means of establishing a communications link between the computers can be used.

According to some example embodiments, the computing device 1300 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can further comprise at least Wi-Fi and Bluetooth™ wireless technologies. Thus, the communication can be a predefined structure as with a conventional network or simply an ad hoc communication between at least two devices.

In accordance with some example embodiments, Wi-Fi, or Wireless Fidelity, allows connection to the Internet from a couch at home, a bed in a hotel room, or a conference room at work, without wires. To this end, Wi-Fi referred herein, is a wireless technology similar to that used in a cell phone that enables such devices, e.g., computers, to send and receive data indoors and out; anywhere within the range of a base station. Wi-Fi networks use radio technologies called IEEE802.11 (a, b, g, n, etc.) to provide secure, reliable, fast wireless connectivity. Further, in accordance with some example embodiments described herein, a Wi-Fi network can be used to connect computers or the plurality of electronic devices to each other, to the Internet, and to wired networks (which use IEEE802.3 or Ethernet). Wi-Fi networks operate in the unlicensed 2.4 and 5 GHz radio bands, at an 11 Mbps (802.11b) or 54 Mbps (802.11a) data rate, for example, or with products that contain both bands (dual band), so the networks can provide real-world performance similar to the basic “9BaseT” wired Ethernet networks used in many offices.

As used in this application, the terms “system,” “component,” “interface,” and the like are generally intended to refer to a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. These components also can execute from various computer readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry that is operated by software or firmware application(s) executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. An interface can comprise input/output (I/O) components as well as associated processor, application, and/or API components.

Furthermore, the disclosed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor also can be implemented as a combination of computing processing units.

In the subject specification, terms such as “store,” “data store,” “data storage,” “database,” “repository,” “queue”, and substantially any other information storage component relevant to operation and functionality of a component, refer to “memory components,” or entities embodied in a “memory” or components comprising the memory. It will be appreciated that the memory components described herein can be either volatile memory or nonvolatile memory or can comprise both volatile and nonvolatile memory. In addition, memory components or memory elements can be removable or stationary. Moreover, memory can be internal or external to a device or component, or removable or stationary. Memory can comprise various types of media that are readable by a computer, such as hard-disc drives, zip drives, magnetic cassettes, flash memory cards or other types of memory cards, cartridges, or the like.

By way of illustration, and not limitation, nonvolatile memory can comprise read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated example aspects of the embodiments. In this regard, it will also be recognized that the embodiments comprise a system as well as a computer-readable medium having computer-executable instructions for performing the acts and/or events of the various methods.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can comprise, but are not limited to, RAM, ROM, EEPROM, flash memory or other memory technology, CD ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communications media comprise wired media, such as a wired network or direct-wired connection, and wireless media such as acoustic, RF, infrared and other wireless media

Further, terms like “user equipment,” “user device,” “mobile device,” “mobile,” station,” “access terminal,” “terminal,” “handset,” and similar terminology, generally refer to a wireless device utilized by a subscriber or user of a wireless communication network or service to receive or convey data, control, voice, video, sound, gaming, or substantially any data-stream or signaling-stream. The foregoing terms are utilized interchangeably in the subject specification and related drawings. Likewise, the terms “access point,” “node B,” “base station,” “evolved Node B,” “cell,” “cell site,” and the like, can be utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows. It is noted that in the subject specification and drawings, context or explicit distinction provides differentiation with respect to access points or base stations that serve and receive data from a mobile device in an outdoor environment, and access points or base stations that operate in a confined, primarily indoor environment overlaid in an outdoor coverage area. Data and signaling streams can be packetized or frame-based flows.

Furthermore, the terms “user,” “subscriber,” “customer,” “consumer,” and the like are employed interchangeably throughout the subject specification, unless context warrants particular distinction(s) among the terms. It should be appreciated that such terms can refer to human entities, associated devices, or automated components supported through artificial intelligence (e.g., a capacity to make inference based on complex mathematical formalisms) which can provide simulated vision, sound recognition and so forth. In addition, the terms “wireless network” and “network” are used interchangeable in the subject application, when context wherein the term is utilized warrants distinction for clarity purposes such distinction is made explicit.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, while a particular feature may have been disclosed with respect to only one of several implementations, such feature may be combined with one or more other features of the other implementations as may be desired and advantageous for any given or particular application. Furthermore, to the extent that the terms “includes” and “including” and variants thereof are used in either the detailed description or the claims, these terms are intended to be inclusive in a manner similar to the term “comprising.”

The above descriptions of various embodiments of the subject disclosure and corresponding figures and what is described in the Abstract, are described herein for illustrative purposes, and are not intended to be exhaustive or to limit the disclosed embodiments to the precise forms disclosed. It is to be understood that one of ordinary skill in the art may recognize that other embodiments having modifications, permutations, combinations, and additions can be implemented for performing the same, similar, alternative, or substitute functions of the disclosed subject matter, and are therefore considered within the scope of this disclosure. Therefore, the disclosed subject matter should not be limited to any single embodiment described herein, but rather should be construed in breadth and scope in accordance with the claims below.

It may be noted that, as used in this specification and the appended claims, the singular forms “a,” “an” and “the” comprise plural referents unless the content clearly dictates otherwise.

References within the specification to “one embodiment,” “an embodiment,” “embodiments”, or “one or more embodiments” are intended to indicate that a particular feature, structure, or characteristic described in connection with the embodiment is comprised in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others.

It should be noted that, when employed in the present disclosure, the terms “comprises,” “comprising,” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

Detailed embodiments are disclosed herein; however, it is to be understood that the disclosed embodiments are merely exemplary, which may be embodied in various forms. Therefore, specific structural and functional details disclosed herein are not to be interpreted as limiting, but merely as a basis for the claims.

While it is apparent that the illustrative embodiments described herein disclosed fulfill the objectives stated above, it will be appreciated that numerous modifications and other embodiments may be devised by one of ordinary skill in the art. Accordingly, it will be understood that the appended claims are intended to cover all such modifications and embodiments, which come within the spirit and scope of the present disclosure.

What is claimed is:

1. A system comprising:
a host computer communicatively coupled to a first electronic device, wherein the host computer comprises a processor configured to:
transmit one or more workflow tasks to the first electronic device;
receive sensor information from a plurality of sensors, wherein the sensor information comprises at least one of a location of the first electronic device or data related to the one or more workflow tasks being performed by a worker; and
transmit, to the first electronic device, real-time information to be communicated to the worker based on the sensor information received from the plurality of sensors, wherein the real-time information comprises instructions in form of an assistance to be provided to the worker for performing the one or more workflow tasks.

2. The system of claim 1, wherein the processor is further configured to:
determine whether the sensor information matches a predefined ergonomic profile indicative of a standard performance behavior of the worker while performing the one or more workflow tasks; and
in response to determining that the sensor information matches with the predefined ergonomic profile, transmit, to the first electronic device, the real-time information to the worker indicative of the standard performance behavior of the worker.

3. The system of claim 2, wherein the processor is further configured to:
in response to determining that the sensor information does not match the predefined ergonomic profile, transmit, to the first electronic device, the real-time information to the worker indicative of an improper performance behavior of the worker, wherein the real-time information comprises ergonomic feedback to the worker.

4. The system of claim 2, wherein the processor is further configured to:
in response to the determining that the sensor information does not match the predefined ergonomic profile, generate a notification indicating that the worker is following an improper performance behavior; and
transmit the notification to a supervisor device, or a remote device to take corrective actions.

5. The system of claim 1, wherein the sensor information further comprises at least one of movement information, orientation information, environmental information, or any combination thereof.

6. The system of claim 1, wherein the plurality of sensors comprises at least one of a plurality of motion sensors, altitude sensors, location sensors, image sensors, environmental sensors, position sensors, proximity sensors, light sensors, or any combination thereof.

7. The system of claim 2, wherein the processor is configured to transmit the real-time information to the first electronic device that comprises at least one of:
issuing an audible command to the first electronic device; and
displaying a warning message on a display of the first electronic device.

8. The system of claim 1, wherein the instructions in form of the assistance to the worker comprises at least one of:
directing the worker to use a special equipment,
warning the worker of upcoming dangerous situation,
suggesting the worker to comply with safety requirements, or
providing the worker safety suggestions.

9. The system of claim 3, wherein the processor is further configured to:
record, in a database, the improper performance behavior flagged to the worker by the host computer, wherein the recorded improper performance behavior is used by the host computer for future training purpose.

10. A system comprising:
a memory to store computer-executable instructions:
a processor, that performs operations in response to executing the computer-executable instructions, the operations comprising:
transmitting an inspection plan comprising a sequence of inspection steps to a first inspection assistance device associated with a worker;
receiving sensor information from a plurality of sensors, wherein the sensor information comprises data related to the sequence of inspection steps to be performed using the first inspection assistance device;
evaluating a performance of the worker in real-time based on comparing the received sensor information with an AI based trained model; and
in response to the evaluation of the performance of the worker, transmitting real-time information to the first inspection assistance device, wherein the real-time information comprises instructions in form of assistance to be provided to the worker for performing an inspection.

11. The system of claim 10, wherein the first inspection assistance device transmits one or more commands corresponding to the sequence of inspection steps to the worker for performing the inspection.

12. The system of claim 11, wherein the operations further comprising:
generating a performance rating of the worker based on the comparison between the received sensor information and the AI based trained model, wherein the performance rating is generated based on at least one of an inspection completion quality, time taken to complete the inspection, and an error percentage of the worker.

13. The system of claim 10, wherein the real-time information to the worker further includes:
transmitting, to the first inspection assistance device, real-time training instructions so that the worker receives a real-time training from at least one of an expert, an admin, a supervisor, or a trainer, wherein the real-time training comprises at least one of:
playing on a speaker associated with the first inspection assistance device, an audible training command to provide the real-time training to the worker, or
displaying on a display of the first inspection assistance device, a live training video from the expert.

14. The system of claim 10, wherein the operations further comprising:
receiving an inspection result from the first inspection assistance device in response to completion of each inspection step of the inspection plan.

15. The system of claim 14, wherein the operations further comprising:
receiving from the worker via the first inspection assistance device, feedbacks and observations while performing the inspection; and
dynamically updating the AI based trained model based on the received inspection result and the feedbacks.

16. A method comprising:
transmitting one or more workflow tasks from a host computer to a first electronic device communicatively coupled to the host computer;
receiving sensor information from a plurality of sensors, wherein the sensor information comprises at least one of a location of the first electronic device or data related to the one or more workflow tasks being performed by a worker; and
transmitting, to the first electronic device, a real-time information to be communicated to the worker based on the sensor information received from the plurality of sensors, wherein the real-time information comprises instructions in form of an assistance to be provided to the worker for performing the one or more workflow tasks.

17. The method of claim 16, further comprising:
determining whether the sensor information matches a predefined ergonomic profile indicative of a standard performance behavior of the worker while performing the one or more workflow tasks; and
in response to determining that the sensor information matches with the predefined ergonomic profile, transmitting, to the first electronic device, the real-time information to the worker indicative of the standard performance behavior of the worker.

18. The method of claim 17, further comprising:
in response to determining that the sensor information does not match the predefined ergonomic profile, transmitting, to the first electronic device, the real-time information to the worker indicative of an improper performance behavior of the worker, wherein the real-time information comprises ergonomic feedback to the worker.

19. The method of claim 17, further comprising:
in response to the determining that the sensor information does not match the predefined ergonomic profile, generating a notification indicating that the worker is following an improper standard performance behavior; and
transmitting the notification to a supervisor device, or a remote device to take corrective actions.

20. The method of claim 16, wherein transmitting the real-time information comprises at least one of:
issuing an audible command to the first electronic device; and
displaying a warning message on a display of the first electronic device.
